(19) United States
(12) Patent Application Publication
(10) Pub. No.: US 2021/0291127 A1
(43) Pub. Date: Sep. 23, 2021

(54) FLUID MIXER

(71) Applicant: TIME ENGINEERING CO., LTD, Oguchi-cho (JP)

(72) Inventors: Minoru HISHIKAWA, Oguchi-cho (JP); Yoshimasa MURAI, Oguchi-cho (JP)

(21) Appl. No.: 16/613,285

(22) PCT Filed: Jul. 23, 2018
(86) PCT No.: PCT/JP2018/027461

§ 371 Date: Nov. 13, 2019

(30) Foreign Application Priority Data
Aug. 3, 2017 (JP) 2017-150821

(51) Int. Cl. B01F 5/04; B01F 15/04; B01F 3/02; F23D 14/02; F23D 14/64; F23N 1/02; F23D 14/00

(52) U.S. Cl. CPC B01F 5/0415; B01F 5/0428; B01F 15/0433; B01F 3/028; B01F 2215/0085; F23D 14/64; F23N 1/025; F23N 1/027; F23D 14/00; F23D 14/02

(57) ABSTRACT

A fluid mixer configured to stably supply a mixed fluid having a desired mixing ratio, and which can be reduced in size. This fluid mixer includes a Venturi tube having a constriction section at which the flow path area is reduced, the Venturi tube having formed therein a first inflow opening and a second inflow opening through which a second fluid flows into a low-pressure region produced due to an increase in fluid velocity when a first fluid passes through the constriction section. A valve body that is disposed within the Venturi tube, the valve body closing due to the pressure of the first fluid passing through the Venturi tube and changing the flow path area of the Venturi tube, blocking off the first inflow opening when closed, and opening the first inflow opening when opened; and a biasing part (elastic body) applying a biasing force in the valve closing direction of the valve body.

### TECHNICAL FIELD

The present invention relates to a fluid mixer.

### BACKGROUND ART

Patent Literature 1 discloses a conventional fluid mixer incorporated in a combustion apparatus having a blower for supplying combustion air to a burner. This fluid mixer is coupled downstream or upstream of the blower. This fluid mixer includes a Venturi tube and two valve bodies. The Venturi tube has a constriction section at which a flow path area is reduced. In the Venturi tube, a low-pressure region is generated due to an increase in the fluid velocity of the combustion air passing through the constriction section. In this Venturi tube, the flow path of the constriction section is divided into two by a partition member extending in the flow path direction. This Venturi tube has an inflow opening for fuel gas formed in each low-pressure region of the flow path of the constriction section divided into two by the partition member. Therefore, when the blower is driven, the fluid mixer sucks the fuel gas from the inflow opening when the combustion air passes through the Venturi tube, and the fluid mixer is thus capable of supplying to the burner the mixed gas in which the combustion air and the fuel gas are mixed.

The two valve bodies are rotatably supported at the upstream end portion and the downstream end portion of the partition member. These two valve bodies open and close one of the flow paths of the constriction section divided into two at a position separated in the flow path direction. Each valve body is opened by the pressure of air passing through the Venturi tube. The pressure of the air passing through the Venturi tube increases as the flow rate (the amount of fluid flowing per unit time: the same is true hereinafter) of the air passing through the Venturi tube increases. That is, the pressure of the air passing through the Venturi tube increases as the rotation speed of the blower increases. When a first valve body, which is rotatably supported at the upstream end portion of the partition member, is opened, the first valve body closes one inflow opening whose tip end side is formed at the constriction section. When the first valve body is opened, it opens the inflow opening. A second valve body, which is rotatably supported at the downstream end portion of the partition member, is formed so as to open at a pressure greater than the pressure of air required for the first valve body to open.

When the combustion apparatus into which the fluid mixer is incorporated is to be combusted at a low combustion amount, the blower is rotated at a low set rotation speed. In this case, the fluid mixer is in a state where the first valve body and the second valve body are closed, and supplies a mixed gas having a small flow rate to the burner. On the other hand, the combustion apparatus rotates the blower at a high set rotation speed, when performing combustion at a high combustion amount. In this case, the fluid mixer is in a state where the first valve body and the second valve body are opened, and supplies a mixed gas having a large flow rate to the burner. Thus, when the fluid mixer performs combustion at a high combustion amount, the air passing through the Venturi tube has a pressure enough to open the second valve body, and hence the first valve body is stably maintained in a completely opened state, and the mixed gas having an air-fuel ratio appropriate for combustion can be stably supplied to the burner.

### CITATIONS LIST

### Patent Literature

Patent Literature 1: U.S. Patent Application Publication No. 2013/0224670

### SUMMARY OF INVENTION

### Technical Problems

However, the fluid mixer of Patent Literature 1 is provided with two valve bodies at positions separated in the flow path direction. For this reason, it is difficult to reduce the size of the fluid mixer. Furthermore, the fluid mixer requires time and effort to adjust the opening/closing timing of the two valve bodies, and if the opening/closing timing is wrong, the air-fuel ratio (mixing ratio) may not be appropriate.

The present invention has been made in view of the above-described conventional situation. An object of the present invention is to provide a fluid mixer that can stably supply a mixed fluid having a desired mixing ratio and can be downsized.

### Solutions to Problems

A fluid mixer according to the first embodiment of the present invention includes:

a Venturi tube having a constriction section at which the flow path area is reduced, the Venturi tube having a plurality of inflow openings formed therein, through which a second fluid flows into a low-pressure region generated due to an increase in fluid velocity when a first fluid passes through the constriction section;

a valve body disposed in the Venturi tube, the valve body opened due to the pressure of the first fluid passing through the Venturi tube and changing the flow path area of the Venturi tube, as well as blocking some of the plurality of inflow openings when the valve body is closed, and opening the same when the valve body is opened; and
a biasing part applying a biasing force in the valve closing direction of the valve body,

wherein the valve body has a protrusion portion inserted into the inflow opening,

the cross-sectional area of the protrusion portion is configured to be smaller than the opening area of the inflow opening.

A fluid mixer according to the second embodiment of the present invention includes:

a Venturi tube having a constriction section at which the flow path area is reduced, the Venturi tube having a plurality of inflow openings formed therein, through which a second fluid flows into a low-pressure region generated due to an increase in fluid velocity when a first fluid passes through the constriction section;

a valve body disposed in the Venturi tube, the valve body opened due to the pressure of the first fluid passing through the Venturi tube and changing the flow path area of the Venturi tube, as well as blocking some of the plurality of inflow openings when the valve body is closed, and opening the same when the valve body is opened; and

a biasing part applying a biasing force in the valve closing direction of the valve body,

wherein the biasing part has a magnet applying a magnetic force in the valve closing direction.

A fluid mixer according to the third embodiment of the present invention includes:

a Venturi tube having a constriction section at which the flow path area is reduced, the Venturi tube having a plurality of inflow openings formed therein, through which a second fluid flows into a low-pressure region generated due to an increase in fluid velocity when a first fluid passes through the constriction section;

a valve body disposed in the Venturi tube, the valve body opened due to the pressure of the first fluid passing through the Venturi tube and changing the flow path area of the Venturi tube, as well as blocking some of the plurality of inflow openings when the valve body is closed, and opening the same when the valve body is opened; and

a biasing part applying a biasing force in the valve closing direction of the valve body,

wherein the valve body is formed divided, where a pressure of the first fluid passing through the Venturi tube when each divided valve body is opened is different, and the inflow opening is blocked for each divided valve body when the valve is closed, and the inflow opening is opened for each divided valve body when the valve is opened.

A fluid mixer according to the fourth embodiment of the present invention includes:

a Venturi tube having a constriction section at which the flow path area is reduced, the Venturi tube having a plurality of inflow openings formed therein, through which a second fluid flows into a low-pressure region generated due to an increase in fluid velocity when a first fluid passes through the constriction section;

a valve body disposed in the Venturi tube, the valve body opened due to the pressure of the first fluid passing through the Venturi tube and changing the flow path area of the Venturi tube, as well as blocking some of the plurality of inflow openings when the valve body is closed, and opening the same when the valve body is opened; and

a biasing part applying a biasing force in the valve closing direction of the valve body,

wherein the fluid mixer comprising an adjusting section adjusting a pressure of the first fluid passing through the Venturi tube when the valve body is opened so as to be different.

The fluid mixer of the first to fourth embodiments has one valve body that changes the flow path area of the Venturi tube, and the biasing force of the biasing part acts on the valve body in the valve closing direction. For this reason, in the fluid mixer, the valve body is opened when the pressure of the first fluid passing through the Venturi tube overcomes the biasing force of the biasing part. Therefore, the fluid mixer includes the biasing part that generates an appropriate biasing force, thereby allowing the valve body not to be opened in a situation where the pressure of the first fluid passing through the Venturi tube is small and the valve opening state of the valve body becomes unstable, and allowing the valve opening state to be stabilized by the pressure of the first fluid passing through the Venturi tube in a situation where the valve body is opened. In this manner, in the fluid mixer, the valve body stably maintains the valve opening state, and hence the suction of the second fluid from the inflow opening is stabilized, thereby allowing the mixed fluid of a desired mixing ratio to be stably supplied. The pressure of the first fluid passing through the Venturi tube increases as the flow rate of the first fluid passing through the Venturi tube increases.

Furthermore, since the fluid mixer of the first to fourth embodiments has one valve body, the length in the flow path direction can be shortened.

Accordingly, the fluid mixer of the present invention can stably supply a mixed fluid of a desired mixing ratio and can be downsized.

In addition, in the fluid mixer of the first to fourth embodiments, the pressure of the first fluid passing through the Venturi tube when the valve body is opened can be made different by making the biasing force of the biasing part different. In other words, by changing the biasing force of the biasing part, the fluid mixer can change the pressure with which the valve body is opened.

In the fluid mixer of the first embodiment, the valve body has a protrusion portion inserted into the inflow opening. Therefore, it is possible to suppress a rapid change in the flow rate of the second fluid flowing in from the inflow opening at the time of switching between the valve opening and the valve closing.

In the fluid mixer of the second embodiment, by providing a magnet that generates an appropriate magnetic force, the valve body is not opened in a situation where the pressure of the first fluid passing through the constriction section is small and the valve opening state of the valve body becomes unstable, and in a situation where the valve body is opened, the valve opening state can be stabilized by the pressure of the first fluid passing through the constriction section.

In the fluid mixer of the third embodiment, the fluid mixer can finely control the flow rate of the mixed fluid.

In the fluid mixer of the fourth embodiment, the fluid mixer can easily change the pressure with which the valve body is opened.

### BRIEF DESCRIPTION OF DRAWINGS

FIG. 1 is a cross-sectional perspective view showing a fluid mixer according to a first embodiment.

FIG. 2 is a cross-sectional view showing a valve closing state of the fluid mixer according to the first embodiment.

FIG. 3 is a cross-sectional view showing a valve opening state of the fluid mixer according to the first embodiment.

FIG. 4 is a schematic view in which the fluid mixer of the first embodiment is incorporated in a combustion apparatus.

FIG. 5 is a graph showing the relationship between the rotation speed of the blower and the flow rate of the mixed gas flowing through the Venturi tube when the fluid mixer of the first embodiment is incorporated in the combustion apparatus.

FIG. 6 is a perspective view showing a fluid mixer according to a second embodiment.

FIG. 7 is a graph showing the relationship between the rotation speed of the blower and the flow rate of the mixed gas flowing through the Venturi tube when the fluid mixer of the second embodiment is incorporated in the combustion apparatus.

FIG. 8 is a fluid mixer according to a third embodiment, where (A) is a schematic view showing the relationship between the valve body and the inner cylinder, and (B) is a cross-sectional view showing the valve closing state.

FIG. 9 is a cross-sectional view showing the valve opening state of the fluid mixer according to the third embodiment.

FIG. 10 is a cross-sectional view showing another embodiment of the fluid mixer using an electromagnet.

FIG. 11 is a cross-sectional view showing another embodiment of the fluid mixer utilizing a torsion spring.

FIG. 12 is a schematic cross-sectional view showing another embodiment of the fluid mixer including a valve body that blocks substantially half of the flow path and a valve body that blocks substantially the entire flow path on the downstream side thereof.

FIG. 13 is an another embodiment of the fluid mixer in which a valve body is formed by being divided into two, where (A) is a schematic view of the valve body as viewed from the downstream side of the flow path, and (B) is a schematic cross-sectional view.

FIG. 14 is a cross-sectional perspective view showing a fluid mixer according to a fourth embodiment.

FIG. 15 is a cross-sectional view showing the valve closing state of the fluid mixer of the fourth embodiment.

FIG. 16 is a cross-sectional view showing the valve opening state of the fluid mixer of the fourth embodiment.

FIG. 17 is an enlarged cross-sectional view of main part for explaining the biasing part of the fluid mixer of the fourth embodiment.

FIG. 18 is a view for explaining a protrusion portion of the fluid mixer according to the fourth embodiment, which is an enlarged cross-sectional view of main part showing the valve closing state.

FIG. 19 is a view for explaining a protrusion portion of the fluid mixer according to the fourth embodiment, which is an enlarged cross-sectional view of main part showing the valve opening state.

FIG. 20 is a graph showing the relationship between the rotation speed of the blower and the flow rate of the mixed gas flowing through the Venturi tube when the fluid mixer of the fourth embodiment is incorporated in the combustion apparatus.

FIG. 21 is a view (part 1) for explaining an elastic force adjusting section of a fluid mixer of a fifth embodiment.

FIG. 22 is a view (part 2) for explaining the elastic force adjusting section of the fluid mixer of the fifth embodiment.

### DESCRIPTION OF EMBODIMENTS

Preferred embodiments of the present invention will be described.

In the fluid mixer of the present invention, the biasing part may have an elastic body applying an elastic force in the valve closing direction. In this case, by providing an elastic body that generates an appropriate elastic force, the valve body can be opened at an opening degree corresponding to the flow rate of the first fluid passing through the constriction section, and it is hence possible to cause the second fluid having a flow rate corresponding to the flow rate of the first fluid to flow in.

In the fluid mixer of the present invention, the Venturi tube may be formed with a flow passage communicating with the inflow opening, the flow passage through which the second fluid flows. The fluid mixer may include a flow rate adjusting section provided in the Venturi tube, the flow rate adjusting section adjusting the flow rate of the second fluid flowing through the flow passage. The flow rate adjusting section may have an operating section adjusting the flow rate of the second fluid from the outside of the Venturi tube. In this case, the flow rate of the second fluid can be easily adjusted.

In the fluid mixer of the present invention, the Venturi tube may have an inner cylinder forming the constriction section and an outer cylinder into which the inner cylinder is inserted. By inserting the inner cylinder into the outer cylinder, the flow passage can be formed between the outer peripheral surface of the inner cylinder and the inner peripheral surface of the outer cylinder. In this case, the flow passage can be easily formed in the Venturi tube.

In the fluid mixer of the present invention, the plurality of inflow openings can be a first inflow opening opened and closed by the valve body and a second inflow opening other than the first inflow opening. The flow passage may have a first flow passage communicating with the first inflow opening and a second flow passage communicating with the second inflow opening. The flow rate adjusting section may have a first flow rate adjusting section adjusting the flow rate of a second fluid flowing through the first flow passage, and a second flow rate adjusting section adjusting the flow rate of a second fluid flowing through the second flow passage. In this case, it is possible to individually adjust the flow rate of the second fluid flowing in from each of the inflow opening opened and closed by the valve body and the other inflow opening. It is also possible to obtain a mixed fluid having a desired mixing ratio regardless of whether the valve is opened or closed.

In the fluid mixer of the present invention, the inflow opening opened and closed by the valve body may be formed downstream relative to a part of the constriction section having the smallest flow path area and upstream relative to the tip end position of the valve body when the valve is closed. In this case, the fluid mixer can suck well the second fluid from the inflow opening.

Next, the embodiments 1 to 3 in which the fluid mixer of the present invention is embodied will be described with reference to the drawings.

### First Embodiment

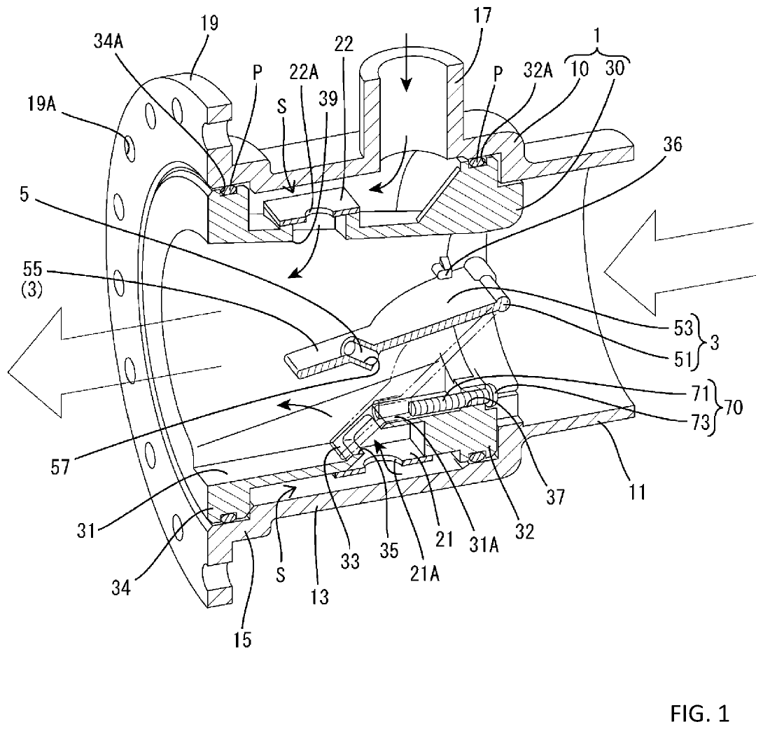

As shown in FIG. 1, the fluid mixer of the first embodiment includes a Venturi tube 1, a valve body 3, and a magnet 5 (illustrated as a biasing part according to the present invention). The Venturi tube 1 is composed of an outer cylinder 10 and an inner cylinder 30. The outer cylinder 10 has an upstream tube portion 11, an intermediate tube portion 13, and a downstream tube portion 15 in this order from the upstream side towards the downstream side. The upstream tube portion 11, the intermediate tube portion 13, and the downstream tube portion 15 are substantially cylindrical. The inner diameter of the upstream tube portion 11 is smaller than the inner diameter of the intermediate tube portion 13. The inner diameter of the intermediate tube portion 13 is smaller than the inner diameter of the downstream tube portion 15. The intermediate tube portion 13 and the downstream tube portion 15 have substantially the same thickness, and the thickness of the upstream tube portion 11 is smaller than that of the intermediate tube portion 13 and the downstream tube portion 15.

In the upstream tube portion 11, the inner diameter of the end portion on the intermediate tube portion 13 side is slightly smaller than the inner diameter on the upstream side. The intermediate tube portion 13 is provided with a supply tube 17 for supplying the second fluid that is formed at one portion on the side surface. In the intermediate tube portion 13, the inner diameter of the end portion on the upstream tube portion 11 side is slightly smaller than the inner diameter on the downstream side. The downstream tube portion 15 has a flange portion 19 extending outward at the downstream end. The flange portion 19 is formed with a plurality of through holes 19A penetrating in the thickness direction. A coupling bolt (unillustrated) is inserted through the through hole 19A when the fluid mixer is coupled to a piping (unillustrated) on the downstream side.

As shown in FIGS. 1 to 3, the inner cylinder 30 is inserted into the outer cylinder 10 from the downstream tube portion 15 side of the outer cylinder 10. The inner cylinder 30 is inserted into and fixed to the outer cylinder 10 in a state where it is arbitrarily rotated about the center axis with respect to the outer cylinder 10. The inner diameter of the inner cylinder 30 is formed smallest at the upstream end portion. The inner cylinder 30 has a rounded inner corner of the upstream end. The inner cylinder 30 gradually expands in diameter from the upstream end portion towards the downstream side. That is, the inner cylinder 30 is inclined such that the inner peripheral surface gradually expands outward towards the downstream. The inner cylinder 30 has an inner diameter of the upstream end portion that is smaller than the inner diameter of the upstream tube portion 11 of the outer cylinder 10. In this way, the inner cylinder 30 forms the constriction section having a reduced flow path area. That is, the fluid mixer constitutes the Venturi tube 1 by the outer cylinder 10 and the inner cylinder 30 that is inserted and fixed into the outer cylinder 10 from the downstream tube portion 15 side of the outer cylinder 10.

The inner cylinder 30 is formed with a groove portion 31 extending in the center axis direction by outwardly recessing a part of the inner peripheral surface. The groove portion 31 is fitted with a tip end position 55 of the valve body 3 when the valve body 3 described later is closed. The groove portion 31 is formed so that the tip end position 55 of the valve body 3 can move when the valve body 3 is opened from the valve closing state and when the valve body 3 is closed from the valve opening state. The groove portion 31 is formed with a valve seat surface 33 in the middle of the outer peripheral surface, the valve seat surface 33 that the tip end portion 55 of the valve body 3 in the valve closing state overlaps. The valve seat surface 33 has a center part formed with a first inflow opening 35 through which the second fluid flows in. Thus, the first inflow opening 35 is formed downstream relative to a part of the constriction section having the smallest flow path area (upstream end portion of the inner cylinder 30). The first inflow opening 35 is formed upstream relative to the tip end position of the valve body 3 when the valve is closed. That is, the first inflow opening 35 is formed in the low-pressure region generated by an increase in the fluid velocity of the first fluid when passing through the inner cylinder 30 (constriction section).

The groove portion 31 forms a recess portion 31A extending in the center axis direction of the inner cylinder 30 continuously to the rear end of the valve seat surface 33. The recess portion 31A is housed with a part of a shaft portion 71 of a bolt 70. The bolt 70 is screwed into a screw hole 37 formed in the rear end portion of the inner cylinder 30 behind the recess portion 31A. That is, the bolt 70 is screwed into the screw hole 37 formed in the rear end portion of the inner cylinder 30, and the shaft portion 71 of the bolt 70 extends in the center axis direction of the inner cylinder 30 and is housed in the recess portion 31A, and the tip end surface of the bolt 70 is disposed so as to face forward. The bolt 70 has a head portion 73 formed with a cross groove exposed to the rear of the inner cylinder 30. For this reason, in a state where the inner cylinder 30 is inserted into and fixed to the outer cylinder 10, the bolt 70 can be rotated with a Phillips head screwdriver inserted from the upstream side opening of the upstream tube portion 11 of the outer cylinder 10. The bolt 70 is made of iron. In the inner cylinder 30, a second inflow opening 39 through which the second fluid flows in is formed on the inner peripheral surface facing the groove portion 31. The second inflow opening 39 is formed in the low-pressure region generated by an increase in the fluid velocity of the first fluid when passing through the inner cylinder 30 (constriction section).

In the inner cylinder 30, the outer diameter of the upstream end portion is slightly smaller than the inner diameter of the end portion of the intermediate portion side the upstream tube portion 11 of the outer cylinder 10. Therefore, when the inner cylinder 30 is inserted into the outer cylinder 10 from the downstream tube portion 15 side of the outer cylinder 10, the upstream end portion of the inner cylinder 30 is inserted into the end portion of the intermediate side of the upstream tube portion 11 of the outer cylinder 10. The inner cylinder 30 is formed with a first flange portion 32 extending outward from the outer peripheral surface on the downstream side of the upstream end portion. The first flange portion 32 has the outer diameter that is slightly smaller than the inner diameter of the end portion on the upstream end portion side of the intermediate tube portion 13 of the outer cylinder 10. The first flange portion 32 is formed with a first recess portion 32A circumferentially around the outer peripheral surface. The first recess portion 32A is fitted with a packing P. Therefore, when the inner cylinder 30 is inserted into the outer cylinder 10 from the downstream tube portion 15 side of the outer cylinder 10, the first flange portion 32 is inserted into the end portion of the upstream end portion side of the intermediate tube portion 13 of the outer cylinder 10, and thus fluid leakage between the first flange portion 32 and the intermediate tube portion 13 of the outer cylinder 10 is prevented. The inner cylinder 30 is formed with a second flange portion 34 extending outward from the outer peripheral surface of the downstream end portion. The second flange portion 34 has the outer diameter that is slightly smaller than the inner diameter of the downstream tube portion 15 of the outer cylinder 10. The second flange portion 34 is formed with a second recess portion 34A circumferentially around the outer peripheral surface. The second recess portion 34A is fitted with the packing P. Therefore, when the inner cylinder 30 is inserted into the outer cylinder 10 from the downstream tube portion 15 side of the outer cylinder 10, the second flange portion 34 is inserted into the downstream tube portion 15 of the outer cylinder 10, and thus fluid leakage between the second flange portion 34 and the downstream tube portion 15 of the outer cylinder 10 is prevented.

The outer diameter of the inner cylinder 30 between the first flange portion 32 and the second flange portion 34 is smaller than the inner diameters of the intermediate tube portion 13 and the downstream tube portion 15 of the outer cylinder 10. For this reason, when the inner cylinder 30 is inserted into the outer cylinder 10 from the downstream tube portion 15 side of the outer cylinder 10, a gap S is formed between the inner cylinder 30 and the outer cylinder 10, between the first flange portion 32 and the second flange portion 34 of the inner cylinder 30. The second fluid supplied from the supply tube 17 formed in the outer cylinder 10 can flow into the inner cylinder 30 from the first inflow opening 35 and the second inflow opening 39 formed in the inner cylinder 30 through the gap S between the inner cylinder 30 and the outer cylinder 10 thus formed.

The gap S communicates with the first inflow opening 35 and the second inflow opening 39. The gap S is a flow passage through which the second fluid supplied from the supply tube 17 flows. The gap S is provided with orifice plates 21 and 22. The orifice plates 21 and 22 adjust the flow rate of the second fluid flowing into the Venturi tube 1 from the first inflow opening 35 and the second inflow opening 39. As shown in FIGS. 1 to 3, the orifice plates 21 and 22 are detachably attached to the outer peripheral surface of the inner cylinder 30 so as to cover the first inflow opening 35 and the second inflow opening 39, respectively, from the gap S side. The orifice plates 21 and 22 are respectively formed with holes 21A and 22A having an opening area smaller than the opening area of each of the first inflow opening 35 and the second inflow opening 39, which are the corresponding inflow openings. By exchanging and attaching the orifice plates 21 and 22 with the holes 21A and 22A having different sizes, it is possible to adjust the flow rate of the second fluid flowing through the gap S into the Venturi tube 1 from the inflow openings 35 and 39. It is to be noted that the orifice plates 21 and 22 are exchanged by taking out the inner cylinder 30 from the outer cylinder 10.

The inner cylinder 30 is formed with a contact stopping portion 36 that comes into contact with the valve body 3 when the valve body 3, which will be described later, is in the valve opening state, the contact stop portion 36 protruding inward from the inner peripheral surface. The contact stopping portion 36 is formed such that the valve body 3, which is opened by the pressure of the first fluid passing through the inner cylinder 30, comes into contact at a position slightly inclined with respect to the flow direction of the first fluid before the valve body 3 rotates to a position parallel to the flow direction of the first fluid. As described above, the fluid mixer is configured such that the valve body 3 in the valve opening state is brought into contact with the contact stopping portion 36, and the valve body 3 in the valve opening state thereby does not flutter by the first fluid passing through the inner cylinder 30.

At the upstream end portion of the inner cylinder 30, the rear end edge of the valve body 3 is continuous to a rotating shaft 51 that passes through the center of the flow path and is rotatably supported at both ends by the inner peripheral surface of the inner cylinder 30. The valve body 3 has a main body portion 53 in which the rotating shaft 51 is continuous to the rear end edge, and the tip end portion 55 that is continuous to the tip end edge of the main body portion 53. The main body portion 53 blocks substantially half of the flow path of the inner cylinder 30 in the valve closing state of the valve body 3. The tip end portion 55 is fitted in the groove portion 31 of the inner cylinder 30 to block the first inflow opening 35 in the valve closing state of the valve body 3. Furthermore, the valve body 3 has a bottomed cylindrical portion 57 that houses the magnet 5 formed on the main body portion 53 side of the tip end portion 55. The cylindrical portion 57 is formed such that the outer surface of the bottom portion faces the tip end surface of the bolt 70 screwed into the screw hole 37 formed in the rear end portion of the inner cylinder 30 in the valve closing state of the valve body 3. The magnet 5 is a cylindrical permanent magnet. The magnet 5 is housed in the cylindrical portion 57 formed in the valve body 3.

In the fluid mixer, when the valve body 3 is in the valve closing state, the magnet 5 housed in the housing portion of the valve body 3 and the bolt 70 are magnetically attracted to each other. That is, the magnet 5 acts a magnetic force in the valve closing direction of the valve body 3. Furthermore, it is possible to bring the magnet 5 housed in the cylindrical portion 57 of the valve body 3 in the valve closing state and the tip end surface of the bolt 70 close to or away from each other, depending on the screwing condition of the bolt 70. As described above, by changing the distance between the magnet 5 and the tip end surface of the bolt 70, it is possible to change the pressure of the first fluid passing through the Venturi tube 1 when the valve body 3 is opened. In other words, in the fluid mixer, when the distance between the magnet 5 and the tip end surface of the bolt 70 is made close, the magnetic force that causes the valve body 3 to act in the valve closing direction becomes strong, and hence the pressure of the first fluid passing through the Venturi tube 1 when the valve body 3 is opened becomes high (the flow rate of the first fluid passing through the Venturi tube 1 becomes high). On the other hand, in the fluid mixer, when the distance between the magnet 5 and the tip end surface of the bolt 70 is kept away, the magnetic force that causes the valve body 3 to act in the valve closing direction becomes weak, and hence the pressure of the first fluid passing through the Venturi tube 1 when the valve body 3 is opened becomes low (the flow rate of the first fluid passing through the Venturi tube 1 becomes low). Thus, in the fluid mixer, the bolt 70 corresponds to an adjusting section that adjusts the pressure of the first fluid passing through the Venturi tube 1 when the valve body 3 is opened so as to be different.

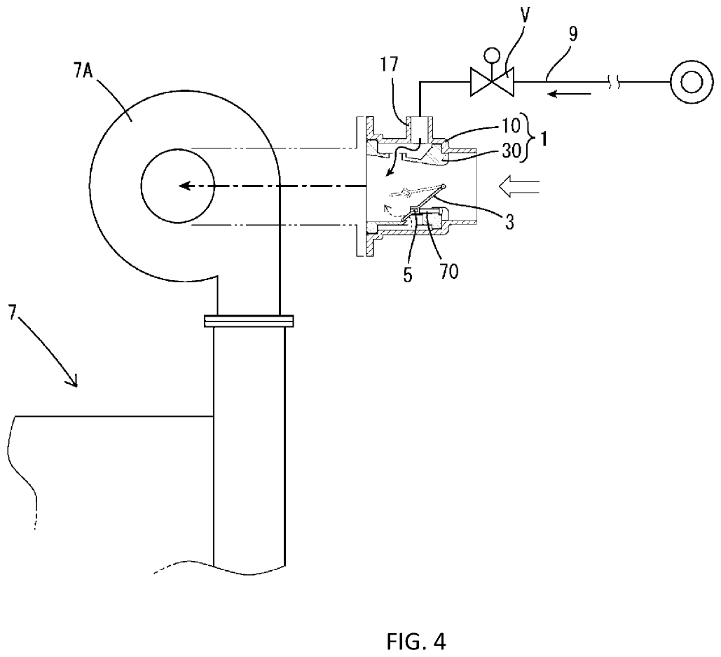

As shown in FIG. 4, when the fluid mixer having such a configuration is used, the fluid mixer is coupled to the upstream side of a blower 7A that supplies combustion air to a burner (unillustrated) of a combustion apparatus 7 such as a gas water heater or a gas boiler. In this case, the first fluid is air and the second fluid is combustion gas. In the fluid mixer, the supply tube 17 formed in the intermediate tube portion 13 of the outer cylinder 10 of the Venturi tube 1 is coupled to a gas supply path 9, and the combustion gas is supplied. The gas supply path 9 has a flow rate adjusting valve V or the like coupled in the middle thereof.

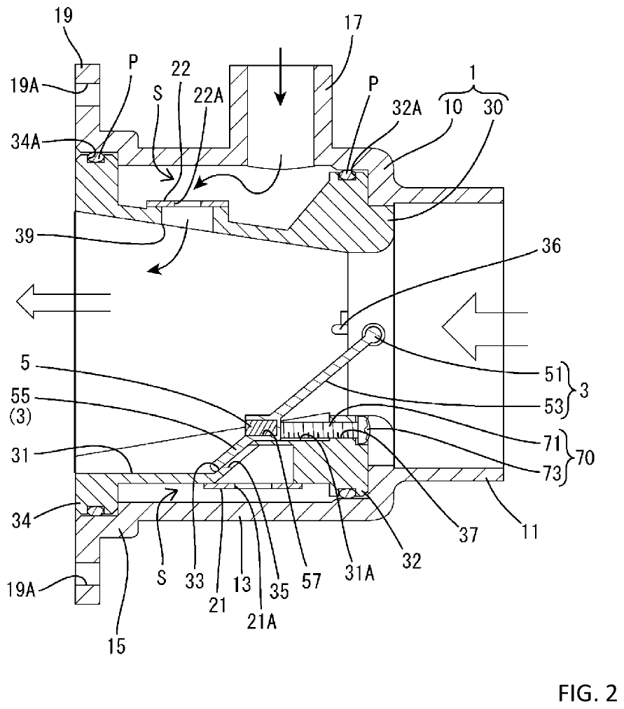

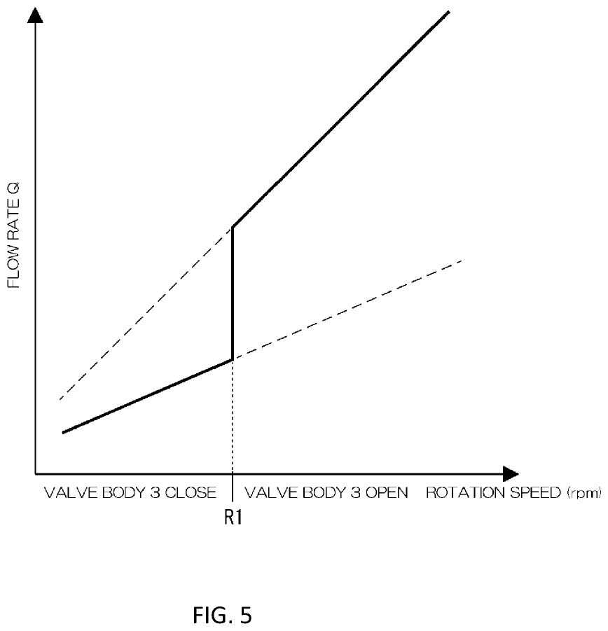

The combustion apparatus 7 in which the fluid mixer is incorporated rotates the blower 7A at a low set rotation speed (rotation speed lower than a rotation speed R1 shown in FIG. 5) in the case of combustion at a low combustion amount. In this case, as shown in FIG. 2, in the fluid mixer, the pressure of the air passing through the inner cylinder 30 of the Venturi tube 1 of the fluid mixer is low, and the magnet 5 provided in the valve body 3 is not possible to overcome the magnetic force that attracts the bolt 70 provided in the inner cylinder 30, so that the valve body 3 is not opened. As described above, when the combustion apparatus 7 is combusted at a low combustion amount, the fluid mixer can supply a small amount of mixed gas (air and combustion gas) at an air-fuel ratio appropriate for combustion by closing the valve body 3 to block about half of the flow path of the Venturi tube 1.

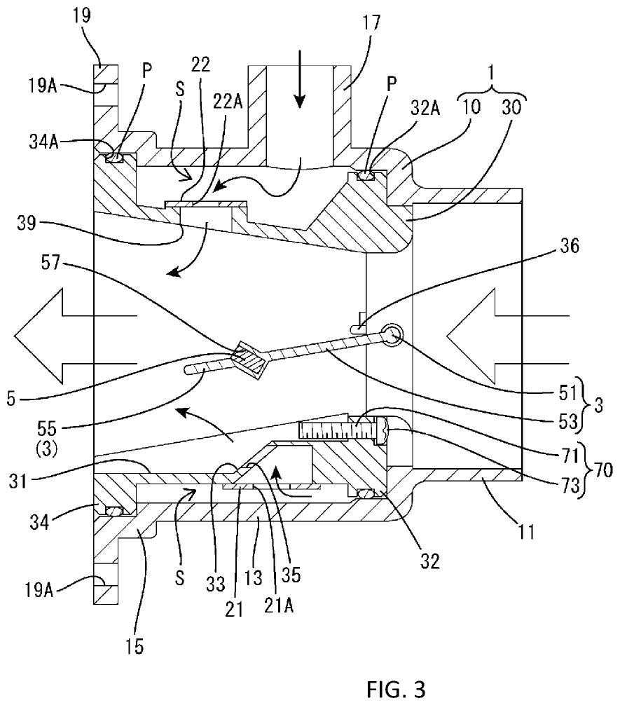

In addition, the combustion apparatus 7 in which the fluid mixer is incorporated rotates the blower 7A at a high set rotation speed (rotation speed higher than a rotation speed R1 shown in FIG. 5) in the case of combustion at a high combustion amount. In this case, in the fluid mixer, as the rotation speed of the blower 7A increases, the pressure of the air passing through the inner cylinder 30 of the Venturi tube 1 of the fluid mixer also increases, and when the pressure of the air overcomes the magnetic force that the magnet 5 provided in the valve body 3 attracts the bolt 70 provided to the inner cylinder 30, the valve body 3 is opened as shown in FIG. 3. In a state where air at a pressure equal to or higher than the pressure at which the valve body 3 is opened passes through the inner cylinder 30 of the Venturi tube 1, the valve body 3 having been opened comes into contact with the contact stopping portion 36, and the valve body 3 does not flutter by the air passing through the inner cylinder 30. In this way, when the combustion apparatus 7 is combusted at a high combustion amount, the fluid mixer can stably supply a large amount of mixed gas (air and combustion gas) at an air-fuel ratio appropriate for combustion by opening the valve body 3 to open the entire flow path of the Venturi tube 1.

Furthermore, in the fluid mixer, the Venturi tube 1 is constituted by the outer cylinder 10 and the inner cylinder 30, and the inner cylinder 30 can be inserted into the outer cylinder 10 and fixed in a state where the inner cylinder 30 is arbitrarily rotated about the center axis with respect to the outer cylinder 10. Therefore, in the fluid mixer, the valve body 3 can be disposed in a specific orientation regardless of the orientation of the supply tube 17 of the outer cylinder 10 coupled to the gas supply path 9. Accordingly, the fluid mixer can be coupled to the gas supply path 9 without being restricted by the orientation of the supply tube 17, because the influence of the own weight of the valve body 3 when the valve body 3 is opened and closed does not change depending on the orientation of the supply tube 17.

### Second Embodiment

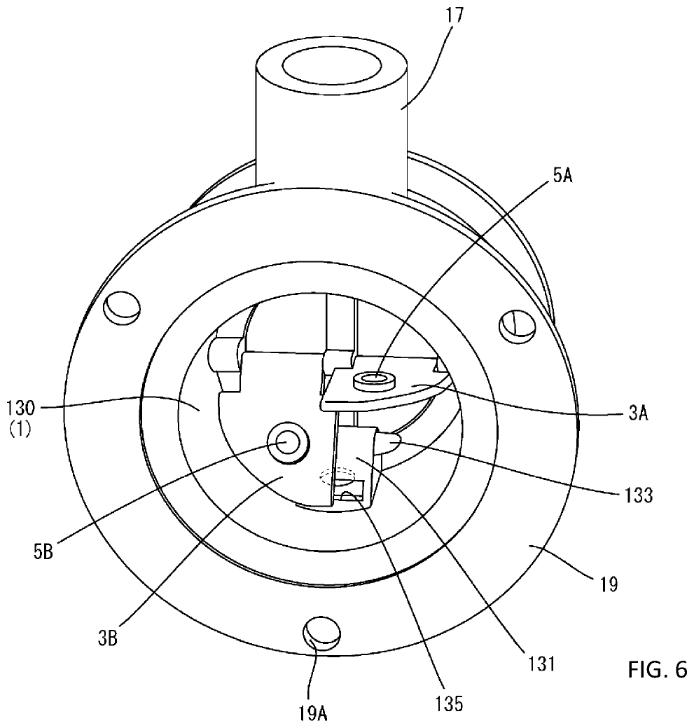

The fluid mixer of the second embodiment is different from that of the first embodiment in that the valve body is formed by being divided into two as shown in FIG. 6. The same configurations as those of the first embodiment are given the identical reference numerals, and detailed description thereof will be omitted.

In the fluid mixer, first valve bodies 3A and 3B divided into two have a symmetrical shape. At the upstream end portion of an inner cylinder 130, the rear end edges of the first valve body 3A and the second valve body 3B are continuous to a rotating shaft that passes through the center of the flow path and is rotatably supported at both ends by the inner peripheral surface of the inner cylinder 130. Approximately half of the flow path of the inner cylinder 130 is blocked by the first valve body 3A and the second valve body 3B. Magnets 5A and 5B having different magnetic forces are fixed to the first valve body 3A and the second valve body 3B, respectively.

The inner cylinder 130 of the fluid mixer has a protrusion portion 131 protruding inward from the inner peripheral surface and having a first inflow opening 135 formed therein. The first inflow opening 135 is formed in the low-pressure region generated by an increase in the fluid velocity of the first fluid when passing through the inner cylinder 130 (constriction section). The first valve body 3A and the second valve body 3B are disposed so as to open and close the first inflow opening 135 by half.

The protrusion portion 131 has iron pieces 133 extending in the left-right direction from both left and right end edges of the upper end portion. The magnets 5A and 5B fixed respectively to the valve bodies 3A and 3B are attracted to each other by a magnetic force acting on each of the iron pieces 133 when the first valve body 3A and the second valve body 3B are in the valve closing state. That is, the magnets 5A and 5B fixed respectively to the first valve body 3A and the second valve body 3B act a magnetic force in the valve closing direction of the valve bodies 3A and 3B.

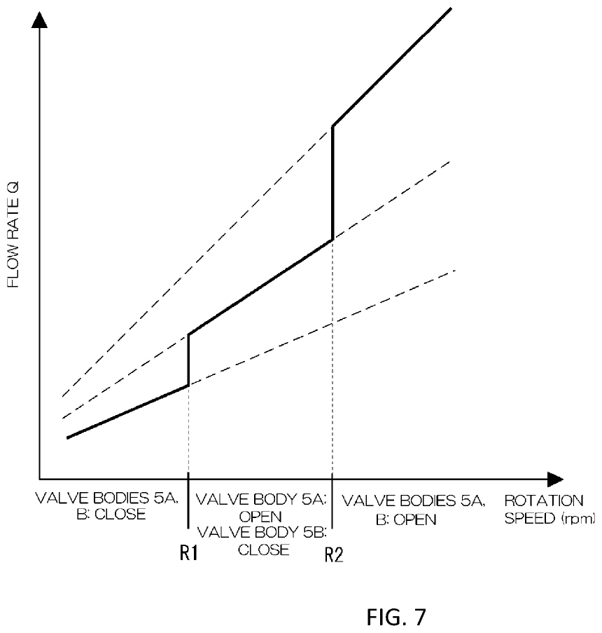

Since in the fluid mixer, the magnets 5A and 5B fixed respectively to the first valve body 3A and the second valve body 3B have different magnetic forces, the pressure of the first fluid passing through the Venturi tube 1 when the first valve body 3A is opened is different from the pressure of the first fluid passing through the Venturi tube 1 when the second valve body 3B is opened. When the magnetic force of the magnet 5B fixed to the second valve body 3B is greater than the magnetic force of the magnet 5A fixed to the first valve body 3A, as shown in FIG. 7, as the pressure of the first fluid passing through the Venturi tube 1 becomes high (the flow rate of the first fluid passing through the Venturi tube 1 increases), the state changes in order of a state where the first valve body 3A and the second valve body 3B are closed, a state where the first valve body 3A is opened and the second valve body 3B is closed, and a state where the first valve body 3A and the second valve body 3B are opened, and the flow rate of the mixed gas (air and combustion gas) having an air-fuel ratio appropriate for combustion gradually increases.

As described above, in the fluid mixer, the flow path area gradually increases as the pressure of the first fluid passing through the Venturi tube 1 increases. That is, the fluid mixer can finely control the flow rate of the mixed fluid.

### Third Embodiment

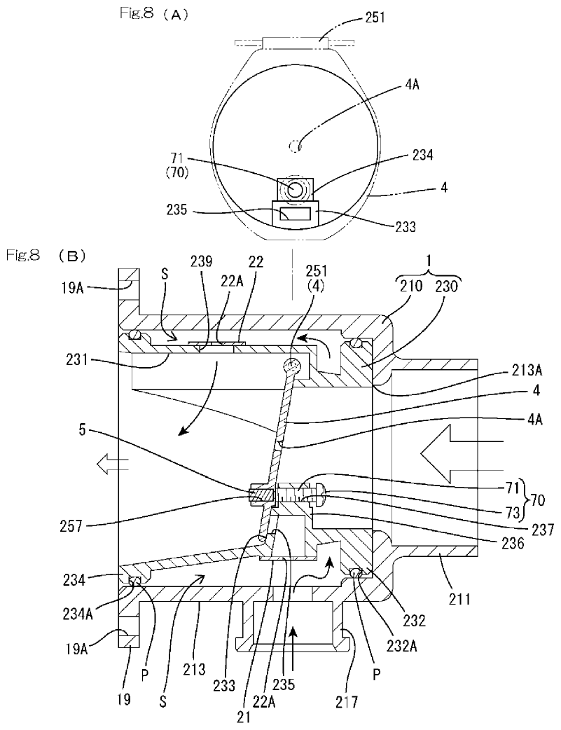

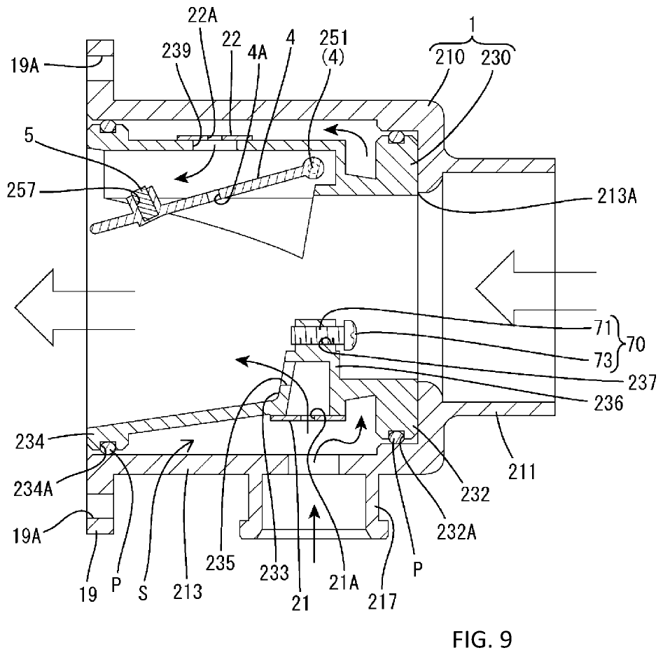

As shown in FIGS. 8 and 9, the fluid mixer of the third embodiment is different from that of the first embodiment in that a valve body 4 is large enough to block the entire flow path of an inner cylinder 230 and has a through hole 4A formed in the center. The same configurations as those of the first embodiment are given the identical reference numerals, and detailed description thereof will be omitted.

An outer cylinder 210 of the fluid mixer is composed of an upstream tube portion 211 and a main tube portion 213 from the upstream side to the downstream side. The upstream tube portion 211 and the main tube portion 213 are substantially cylindrical. The inner diameter of the upstream tube portion 211 is smaller than the inner diameter of the main tube portion 213. The upstream end portion of the main tube portion 213 is bent inward to form an upstream side opening 213A having a diameter smaller than the inner diameter of the upstream tube portion 211. The upstream side corner of the upstream side opening 213A of the main tube portion 213 is rounded. In the main tube portion 213, the inner diameter of the end portion of the upstream tube portion 211 side of the inner peripheral surface is slightly smaller than the inner diameter of the inner peripheral surface on the downstream side thereof.

The inner cylinder 230 is inserted into the outer cylinder 210 from the downstream side of the outer cylinder 210. The inner cylinder 230 is inserted into and fixed to the outer cylinder 210 in a state where it is arbitrarily rotated about the center axis with respect to the outer cylinder 210. The inner diameter of the inner cylinder 230 is formed smallest at the upstream end portion. The inner cylinder 230 gradually expands in diameter from the upstream end portion towards the downstream side. That is, the inner cylinder 230 is inclined such that the inner peripheral surface gradually expands outward towards the downstream. The inner cylinder 230 has an inner diameter of the upstream end portion that is slightly smaller than the inner diameter of the upstream side opening 213A of the main tube portion 213 of the outer cylinder 210. In this way, the inner cylinder 230 forms the constriction section having a reduced flow path area. That is, the fluid mixer constitutes the Venturi tube 1 by the outer cylinder 210 and the inner cylinder 230 that is inserted and fixed into the outer cylinder 210 from the downstream side of the outer cylinder 210.

The inner cylinder 230 is formed with a groove portion 231 extending in the center axis direction by outwardly recessing a part of the inner peripheral surface. In the groove portion 231, a rotating shaft 251 of the valve body 4, which will be described later, extending in a direction perpendicular to the center axis direction and rotatably supported. The groove portion 231 is formed so that a part of the valve body 4 can move when the valve body 4 is opened and closed. The groove portion 231 is formed with a second inflow opening 239 through which the second fluid flows in the outer peripheral surface. The second inflow opening 239 is formed in the low-pressure region generated by an increase in the fluid velocity of the first fluid when passing through the inner cylinder 230 (constriction section).

Furthermore, the inner cylinder 230 is provided with a protrusion portion 236 on the inner peripheral surface facing the groove portion 231, the protrusion portion 236 having a valve seat surface 233 that the tip end side of the valve body 4 in the valve closing state overlaps. The valve seat surface 233 has a center part formed with a first inflow opening 235 through which the second fluid flows in. Thus, the first inflow opening 235 is formed downstream relative to a part of the constriction section having the smallest flow path area (upstream end portion of the inner cylinder 230). The first inflow opening 235 is formed upstream relative to the tip end position of the valve body 4 when the valve is closed. That is, the first inflow opening 235 is formed in the low-pressure region generated by an increase in the fluid velocity of the first fluid when passing through the inner cylinder 230 (constriction section).

The protrusion portion 236 is formed with a screw hole 237 into which the bolt 70 is screwed at the end portion of the center axis side of the inner cylinder 230. The bolt 70 is screwed into the screw hole 237 from the upstream side. That is, the bolt 70 is screwed into the screw hole 237 formed in the protrusion portion 236 of the inner cylinder 230, and the shaft portion 71 of the bolt 70 extends in the center axis direction of the inner cylinder 230 main body part, and the tip end surface of the bolt 70 is disposed so as to face forward. The bolt 70 has a head portion 73 formed with a cross groove exposed to the rear of the inner cylinder 230. For this reason, in a state where the inner cylinder 230 is inserted into and fixed to the outer cylinder 210, the bolt 70 can be rotated with a Phillips head screwdriver inserted from the upstream side opening of the upstream tube portion 211 of the outer cylinder 210. The bolt 70 is made of iron.

The inner cylinder 230 is formed with a first flange portion 232 extending outward from the outer peripheral surface of the upstream end portion. The first flange portion 232 has the outer diameter that is slightly smaller than the inner diameter of the end portion on the upstream tube portion 211 side of the inner peripheral surface of the main tube portion 213 of the outer cylinder 210. The first flange portion 232 is formed with a first recess portion 232A circumferentially around the outer peripheral surface. The first recess portion 232A is fitted with the packing P. Therefore, when the inner cylinder 230 is inserted into the outer cylinder 210 from the downstream side of the outer cylinder 210, the first flange portion 232 is inserted into the end portion of the upstream tube portion 211 side of the inner peripheral surface of the main tube portion 213 of the outer cylinder 210, and thus fluid leakage between the first flange portion 232 and the main tube portion 213 of the outer cylinder 210 is prevented. The inner cylinder 230 is formed with a second flange portion 234 extending outward from the outer peripheral surface of the downstream end portion. The second flange portion 234 has the outer diameter that is slightly smaller than the inner diameter of the main tube portion 213 of the outer cylinder 210. The second flange portion 234 is formed with a second recess portion 234A circumferentially around the outer peripheral surface. The second recess portion 234A is fitted with the packing P. Therefore, when the inner cylinder 230 is inserted into the outer cylinder 210 from the downstream side of the outer cylinder 210, the second flange portion 234 is inserted into the downstream end portion of the main tube portion 213 of the outer cylinder 210, and thus fluid leakage between the second flange portion 234 and the downstream tube portion 15 of the outer cylinder 210 is prevented.

The outer diameter of the inner cylinder 230 between the first flange portion 232 and the second flange portion 234 is smaller than the inner diameter of the main tube portion 213 of the outer cylinder 210. For this reason, when the inner cylinder 230 is inserted into the outer cylinder 210 from the downstream side of the outer cylinder 210, the gap S is formed between the inner cylinder 230 and the outer cylinder 210, between the first flange portion 232 and the second flange portion 234 of the inner cylinder 230. The second fluid supplied from a supply tube 217 formed in the outer cylinder 210 can flow into the inner cylinder 230 from the first inflow opening 235 and the second inflow opening 239 formed in the inner cylinder 230 through the gap S between the inner cylinder 230 and the outer cylinder 210 thus formed.

The rear end edge of the valve body 4 is continuous to the rotating shaft 251 that is rotatably supported by the groove portion 231 of the inner cylinder 230. The valve body 4 blocks the entire flow path of the inner cylinder 230 when the valve is closed, and the tip end side blocks the first inflow opening 235. The valve body 4 has a bottomed cylindrical portion 257 that houses the magnet 5 formed on the tip end side. The cylindrical portion 257 is formed such that the outer surface of the bottom portion faces the tip end surface of the bolt 70 screwed into the screw hole 237 formed in the protrusion portion 236 of the inner cylinder 230 in the valve closing state of the valve body 4. The magnet 5 is a cylindrical permanent magnet. The magnet 5 is housed in the cylindrical portion 257 formed in the valve body 4. The valve body 4 has the through hole 4A formed in the center.

In the fluid mixer, when the valve body 4 is in the valve closing state, the magnet 5 housed in the cylindrical portion 257 of the valve body 4 and the bolt 70 are magnetically attracted to each other. That is, the magnet 5 acts a magnetic force in the valve closing direction of the valve body 4. Furthermore, it is possible to bring the magnet 5 housed in the cylindrical portion 257 of the valve body 4 in the valve closing state and the tip end surface of the bolt 70 close to or away from each other, depending on the screwing condition of the bolt 70. As described above, by changing the distance between the magnet 5 and the tip end surface of the bolt 70, it is possible to change the pressure of the first fluid passing through the Venturi tube 1 when the valve body 4 is opened. In other words, in the fluid mixer, when the distance between the magnet 5 and the tip end surface of the bolt 70 is made close, the magnetic force that causes the valve body 4 to act in the valve closing direction becomes strong, and hence the pressure of the first fluid passing through the Venturi tube 1 when the valve body 4 is opened becomes high (the flow rate of the first fluid passing through the Venturi tube 1 becomes high). On the other hand, in the fluid mixer, when the distance between the magnet 5 and the tip end surface of the bolt 70 is kept away, the magnetic force that causes the valve body 4 to act in the valve closing direction becomes weak, and hence the pressure of the first fluid passing through the Venturi tube 1 when the valve body 4 is opened becomes low (the flow rate of the first fluid passing through the Venturi tube 1 becomes low). Thus, in the fluid mixer, the bolt 70 corresponds to an adjusting section that adjusts the pressure of the first fluid passing through the Venturi tube 1 when the valve body 4 is opened so as to be different.

The combustion apparatus 7 in which the fluid mixer is incorporated rotates the blower 7A at a low set rotation speed in the case of combustion at a low combustion amount. In this case, as shown in FIG. 8, in the fluid mixer, the pressure of the air passing through the inner cylinder 230 of the Venturi tube 1 of the fluid mixer is low, and the magnet 5 provided in the valve body 4 is not possible to overcome the magnetic force that attracts the bolt 70 provided in the inner cylinder 230, so that the valve body 4 is not opened. As described above, when the combustion apparatus 7 is combusted at a low combustion amount, the fluid mixer can supply a small amount of air and combustion gas at an air-fuel ratio appropriate for combustion by closing the valve body 4 so that air flows the downstream side relative to the valve body 4 through the through hole 4A of the valve body 4.

In addition, the combustion apparatus 7 in which the fluid mixer is incorporated rotates the blower 7A at a high set rotation speed in the case of combustion at a high combustion amount. In this case, in the fluid mixer, as the rotation speed of the blower 7A increases, the pressure of the air passing through the inner cylinder 230 of the Venturi tube 1 of the fluid mixer also increases, and when the pressure of the air overcomes the magnetic force that the magnet 5 provided in the valve body 4 attracts the bolt 70 provided to the inner cylinder 230, the valve body 4 is opened as shown in FIG. 9. In a state where air at a pressure equal to or higher than the pressure at which the valve body 4 is opened passes through the inner cylinder 230 of the Venturi tube 1, the valve body 4 having been opened does not flutter by the air passing through the inner cylinder 230. In this way, when the combustion apparatus 7 is combusted at a high combustion amount, the fluid mixer can stably supply a large amount of air and combustion gas at an air-fuel ratio appropriate for combustion by opening the valve body 4 to open the entire flow path of the Venturi tube 1.

As described above, the fluid mixer of the first and third embodiments have one valve bodies 3 and 4, respectively, that change the flow path area of the Venturi tube 1, and the magnetic force of the magnet 5 acts on the valve bodies 3 and 4 in the valve closing direction. Furthermore, in the fluid mixer of the second embodiment, the valve body that changes the flow path area of the Venturi tube 1 is divided into two, and the magnetic force of the magnets 5A and 5B acts on the valve bodies 3A and 3B in the valve closing direction. Therefore, in the fluid mixer, the valve bodies 3, 3A, 3B, and 4 are opened when the pressure of the air passing through the Venturi tube 1 overcomes the magnetic force of the magnets 5, 5A, and 5B. Accordingly, by including the magnet 5 that generates an appropriate magnetic force, the fluid mixer does not open the valve bodies 3, 3A, 3B, and 4 in the situation where the pressure of the air passing through the Venturi tube 1 is small and the valve opening state of the valve bodies 3, 3A, 3B, and 4 becomes unstable, and can stabilize the valve opening state by the pressure of the air passing through the Venturi tube 1 in the situation where the valve bodies 3, 3A, 3B, and 4 are opened. Thus, in the fluid mixer, the valve bodies 3, 3A, 3B, and 4 stably maintain the valve opening state, and hence the suction of the combustion gas from the first inflow openings 35, 135, and 235 is stabilized, thereby allowing the mixed fluid of a desired air-fuel ratio (mixing ratio) to be stably supplied. Since the fluid mixer of the first and third embodiments has only one valve bodies 3 and 4, respectively, and the fluid mixer of the second embodiment has the first valve body 3A and the second valve body 3B that have been obtained by dividing the valve body into two, the length in the flow path direction can be shortened.

Accordingly, the fluid mixer of the embodiments 1 to 3 can stably supply a mixed fluid of a desired mixing ratio and can be downsized.

Furthermore, in the fluid mixer of the embodiments 1 to 3, since the first inflow openings 35, 135, and 235 opened and closed by the valve bodies 3, 3A, 3B, and 4 is formed downstream relative to the part of the constriction section having the smallest flow path area and upstream relative to the tip end position of the valve bodies 3, 3A, 3B, and 4 when the valve is closed, fuel gas can be sucked well from the first inflow openings 35, 135, and 235.

In addition, by making the magnetic force of the magnets 5, 5A, and 5B different, the fluid mixer of the embodiments 1 to 3 can make different the pressure of the air passing through the Venturi tube 1 when the valve bodies 3, 3A, 3B, and 4 are opened. That is, by making the magnetic forces of the magnets 5, 5A, and 5B different, the fluid mixer can easily change the pressure at which the valve body is opened.

In the fluid mixer of the second embodiment, the valve body is formed by being dividing into two, and the pressure of the first fluid passing through the Venturi tube 1 when the first valve body 3A and the second valve body 3B having been divided are opened is different, and the first valve body 3A and the second valve body 3B each open and close the first inflow opening 135 by half. For this reason, the fluid mixer can finely control the flow rate of the mixed fluid, and can easily increase the turn-down ratio.

The fluid mixer of the first and third embodiments can easily change the flow rate of the mixed fluid by adjusting the pressure of the air passing through the Venturi tube 1 when the valve bodies 3 and 4 are opened so as to be different, depending on the screwing condition of the bolt 70.

Next, the embodiments 4 and 5 in which the fluid mixer of the present invention is embodied will be described with reference to the drawings.

### Fourth Embodiment

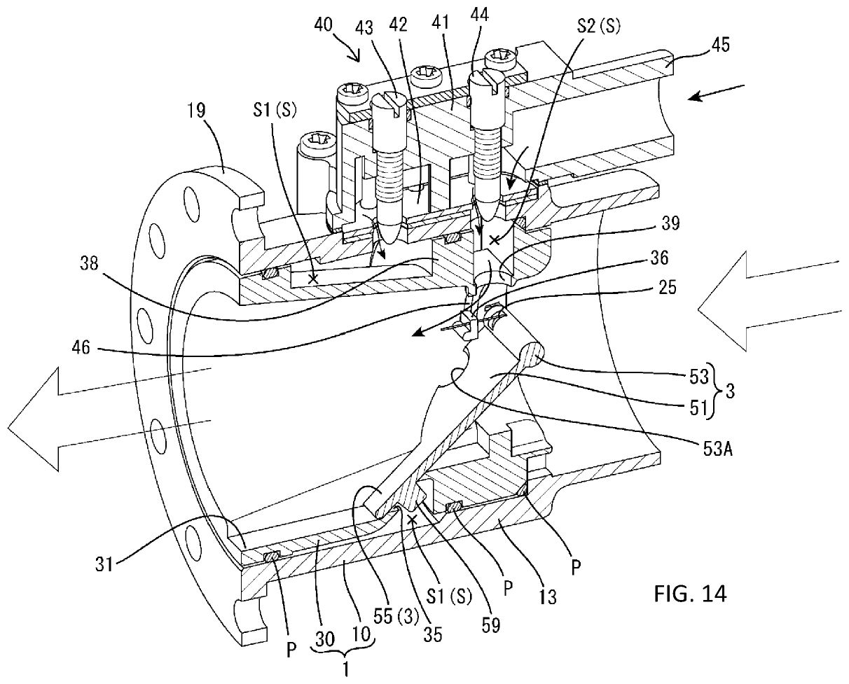

As shown in FIGS. 14 to 16, the fluid mixer of the fourth embodiment is different from that of the first embodiment in that the fluid mixer of the fourth embodiment has an elastic body as a biasing part, that the valve body has a protrusion portion, that the fluid mixer includes a flow rate adjusting section, and the like. The same configurations as those of the first embodiment are given the identical reference numerals, and detailed description thereof will be omitted.

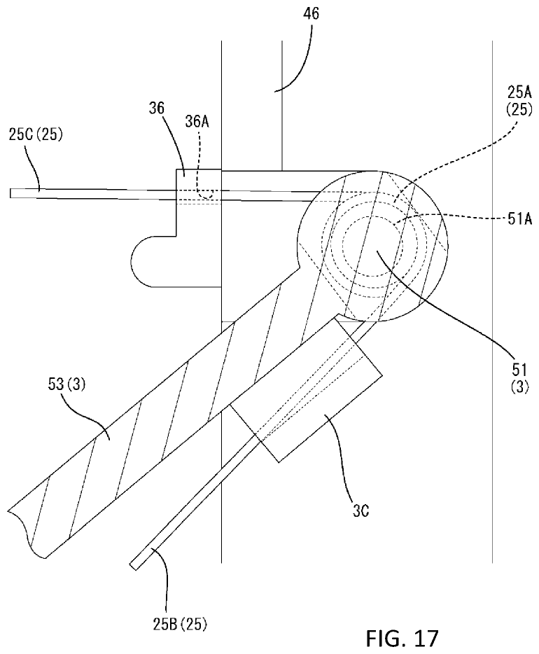

As shown in FIGS. 14 to 16, the fluid mixer of the fourth embodiment includes an elastic body 25 as a biasing part. The valve body 3 of the present embodiment is given an elastic force as a biasing force in the valve closing direction by the elastic body 25. Specifically, the elastic body 25 is configured as a torsion spring as shown in FIG. 17. The elastic body 25 is inserted into a shaft member 51A of the rotating shaft 51 at a coil portion 25A, and one end portion 25B is engaged with an engaging portion 3C of the valve body 3 and the other end portion 25C is inserted into a hole 36A formed in the contact stopping portion 36. Due to this, the elastic body 25 causes its elastic force to act on the direction in which the valve body 3 is closed. In this embodiment, the elastic body 25 is provided at each of the both end portions of the rotating shaft 51.

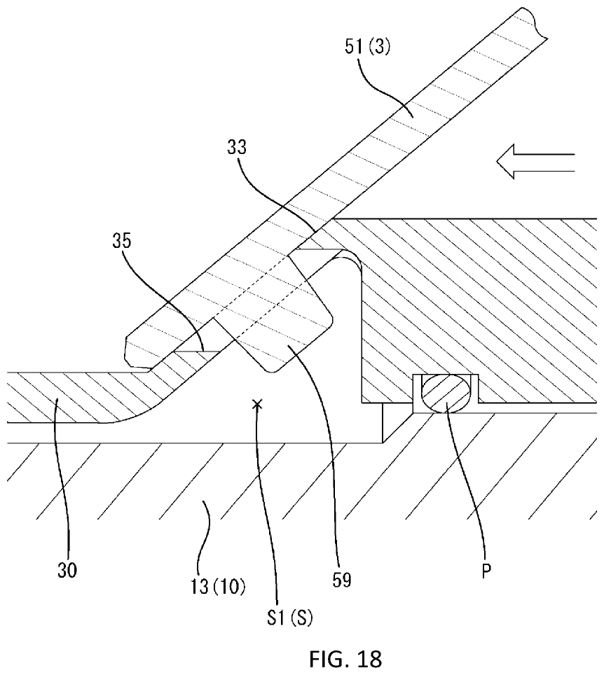

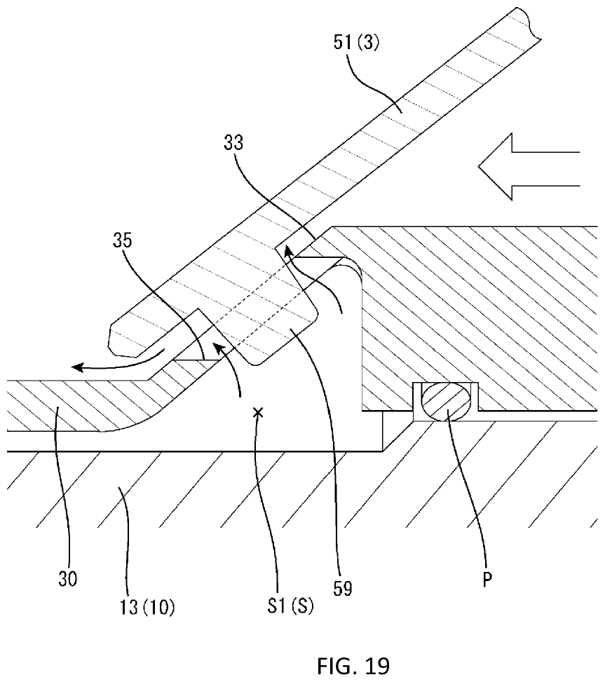

As shown in FIGS. 18 and 19, in the fourth embodiment, the valve body 3 is formed with a protrusion portion 59. The protrusion portion 59 is formed so as to protrude by a predetermined length from one surface of the valve body 3 serving as a contact surface with the valve seat surface 33. The protrusion portion 59 is inserted into the first inflow opening 35. Specifically, as shown in FIG. 18, the protrusion portion 59 is configured to penetrate the first inflow opening 35 and protrude towards the gap S side in a valve closing state in which the valve body 3 comes into contact with the valve seat surface 33. As shown in FIG. 19, even in a state where the valve body 3 is slightly separated from the valve seat surface 33, the protrusion portion 59 is kept inserted into the first inflow opening 35. As shown in FIGS. 18 and 19, the cross-sectional area of the protrusion portion 59 is configured to be smaller than the opening area of the first inflow opening 35, and becomes smaller towards the tip.

As shown in FIGS. 14 to 16, the fluid mixer of the fourth embodiment includes a flow rate adjusting section 40. The flow rate adjusting section 40 is provided in the Venturi tube 1 and adjusts the flow rate of the second fluid flowing through the gap S as the flow passage. In the case of the present embodiment, the gap S has a gap S1 communicating with the first inflow opening 35 and a gap S2 communicating with the second inflow opening 39, and the flow rate adjusting section 40 can separately adjust the flow rate of the second fluid flowing through the gap S1 and the flow rate of the second fluid flowing through the gap S2.

As shown in FIGS. 14 to 16, the flow rate adjusting section 40 is provided on the outer peripheral side of the intermediate tube portion 13 of the outer cylinder 10. The flow rate adjusting section 40 is configured to include a housing 41, an orifice plate 42, two adjustment screws 43 and 44, and a supply tube portion 45. The housing 41 is formed in a box-like shape having on surface open. Furthermore, the housing 41 is formed with female screw portions 41A and 41B on the surface opposite to the surface on the opening side, and adjustment screws 43 and 44 are screwed into the female screw portions 41A and 41B. The housing 41 is detachably attached to the outer peripheral surface of the intermediate tube portion 13 in such a form that the orifice plate 42 is interposed between the housing 41 and the outer peripheral surface of the intermediate tube portion 13 of the outer cylinder 10. The supply tube portion 45 is formed in a tubular shape, with one end coupled to the housing 41 and communicating with a space in the housing 41. The supply tube portion 45 supplies the second fluid to the space in the housing 41, with the other end connected to a supply path for the second fluid (for example, the gas supply path 9 shown in FIG. 4). That is, in the flow rate adjusting section 40, the second fluid is supplied from the supply tube portion 45 to the space in the housing 41. Then, the second fluid that having passed through the housing 41 passes through the orifice plate 42 and flows in the gaps S1 and S2 as flow passages.

The orifice plate 42 is in contact with the outer peripheral surface of the intermediate tube portion 13. In a portion of the intermediate tube portion 13 where the orifice plate 42 comes into contact, two through holes 13A and 13B communicating with the gaps S1 and S2 of the Venturi tube 1, respectively, are formed. The orifice plate 42 is attached so as to cover the through holes 13A and 13B. The orifice plate 42 forms two holes 42A and 42B formed corresponding to the two through holes 13A and 13B. The holes 42A and 42B are formed with opening areas smaller than the opening areas of the corresponding through holes 13A and 13B. It is possible to exchange and attach the orifice plate 42 with the holes 42A and 42B having different sizes.

When exchanging the orifice plate 42, it is not necessary to take out the inner cylinder 30 from the outer cylinder 10 as in the case of exchanging the orifice plates 21 and 22 in the first embodiment, and the orifice plate 42 can be easily exchanged by removing the housing 41 exposed on the outer surface side of the outer cylinder 10.

As shown in FIGS. 14 to 16, the adjustment screw 43, which is one of the two adjustment screws 43 and 44, is engaged with the female screw portion 41A, and the adjustment screw 44, which is the other of the two adjustment screws 43 and 44, is engaged with the female screw portion 41B. In this state, the adjustment screws 43 and 44 can be inserted into the holes 42A and 42B of the orifice plate 42, respectively. By adjusting the amount of insertion into the holes 42A and 42B, the adjustment screws 43 and 44 can adjust the size of the flow path area of the second fluid flowing through the holes 42A and 42B. By adjusting the size of the flow path area in this manner, the flow rates of the second fluid flowing through the gaps S1 and S2 can be adjusted respectively.

The two adjustment screws 43 and 44 have substantially the same configuration. The adjustment screws 43 and 44 have tip end portions 43A and 44A, screw portions 43B and 44B, and operating sections 43C and 44C, respectively. The adjustment screws 43 and 44 are inserted into the housing 41 at their end portions on the tip end portions 43A and 44A side, and screwed into the respective female screw portions 41A and 41B of the housing 41 in a form in which the end portions on the operating sections 43C and 44C side are oriented towards the outside of the housing 41. The adjustment screws 43 and 44 are respectively configured so that the tip end portions 43A and 44A are inserted into the holes 42A and 42B of the orifice plate 42 in a state of being screwed into the female screw portions 41A and 41B. The operating sections 43C and 44C of the adjustment screws 43 and 44 are formed with slits, and the insertion amounts of the tip end portions 43A and 44A into the holes 42A and 42B can be adjusted by engaging a tool with the slits and rotating it. The respective tip end portions 43A and 44A of the adjustment screws 43 and 44 are formed to be tapered.

The flow rate adjusting section 40 of the present embodiment can adjust the flow rate of the second fluid passing through the holes 42A and 42B of the orifice plate 42 by adjusting the insertion amounts of the tip end portions 43A and 44A into the holes 42A and 42B. This allows the flow rate adjusting section 40 to adjust the flow rates of the second fluid flowing through the gaps S1 and S2 independently of each other. That is, the flow rate adjusting section 40 constitutes the first flow rate adjusting section and the second flow rate adjusting section according to the present invention, respectively, by the two adjustment screws 43 and 44 having the operating sections 43C and 44C that adjust the flow rate of the second fluid from the outside of the Venturi tube 1 and the orifice plate 42 having the two holes 42A and 42B formed therein.

It is to be noted that in the flow rate adjusting section according to the present invention, the shape (radial size) of the tip end portions of the adjustment screws and the size of the holes of the orifice plate may be set so that the flow rate is appropriate for the specific two types of the second fluid (for example, city gas, propane gas, and the like) in two types of state, i.e., a state where the adjustment screw is most tightened and a state where the adjustment screw is least tightened, for example. In this case, as compared with the case of adjusting the amount of insertion (screw amount of the adjustment screw) of the tip end portion of the adjustment screw into the hole of the orifice plate, the flow rate adjustment can be performed very easily for the specific two types of the second fluid.

In addition, when using the flow rate adjusting section according to the present invention, for example, a plurality of types of adjustment screws having different shapes of the tip end portions (radial size) may be prepared and exchanged. In this case, the flow rate can be easily adjusted by exchanging with the adjustment screw having the tip end portion of a size corresponding to the specific type of the second fluid.

Furthermore, the flow rate adjusting section may be configured not to have an adjustment screw (operation section), for example. In other words, the flow rate adjusting section may be configured to include an orifice plate that is detachably attached to the outer peripheral surface of the outer cylinder and that is formed with a hole communicating with the flow passage through which the second fluid flows formed on the inner peripheral surface side of the outer cylinder. In this case, the flow rate of the second fluid can be easily adjusted by use of a plurality of orifice plates having different hole diameters having been prepared and exchanged. In this case, since the orifice plate is attached to the outer peripheral surface of the outer cylinder, the orifice plate can be easily exchanged as compared with the case where the inner cylinder is taken out from the outer cylinder.

As described above, in the fluid mixer of the fourth embodiment, the gap S between the outer cylinder 10 and the inner cylinder 30 has the gap S1 communicating with the first inflow opening 35 and the gap S2 communicating with the second inflow opening 39. The gaps S1 and S2 are formed between the outer peripheral surface of the inner cylinder 30 and the inner peripheral surface of the outer cylinder 10 by inserting the inner cylinder 30 into the outer cylinder 10, as in the gap S in the first embodiment. The gap S1 and the gap S2 are partitioned by a partition portion 38. The partition portion 38 is formed so as to radially expand in diameter from the outer peripheral surface of the inner cylinder 30, and is provided in contact with the inner wall of the outer cylinder 10 via the packing P. The gaps S1 and S2 are partitioned in the axial direction of the Venturi tube 1 by the partition portion 38 having such a configuration. The gap S1 is formed on the downstream side in the flow direction of the first fluid in the Venturi tube 1, and the gap S2 is formed on the upstream side in the flow direction of the first fluid in the Venturi tube 1.

In addition, the Venturi tube 1 has a rib 46 formed in a part of the constriction section having the smallest flow path area. The rib 46 is formed to extend from the inner peripheral surface of the inner cylinder 30 towards the center direction. The rib 46 is provided for the purpose of further reducing the flow path area in the part of the constriction section having the smallest flow path area. In other words, the Venturi tube 1 allows the fluid velocity and the flow rate of the first fluid flowing through the constriction section to be freely adjusted by exchanging and using the inner cylinder 30 provided with the rib 46 having different extension amount while keeping the external dimensions.

Furthermore, the valve body 3 has a notch portion 53A formed in the outer peripheral edge of the main body portion 53. The notch portion 53A can flow the first fluid even in the valve closing state. Due to this, by using the valve body 3 having the main body portion 53 in which the notch portion 53A of a desired size is formed, the flow rate of the first fluid at the time of closing the valve can be easily set to a desired flow rate.

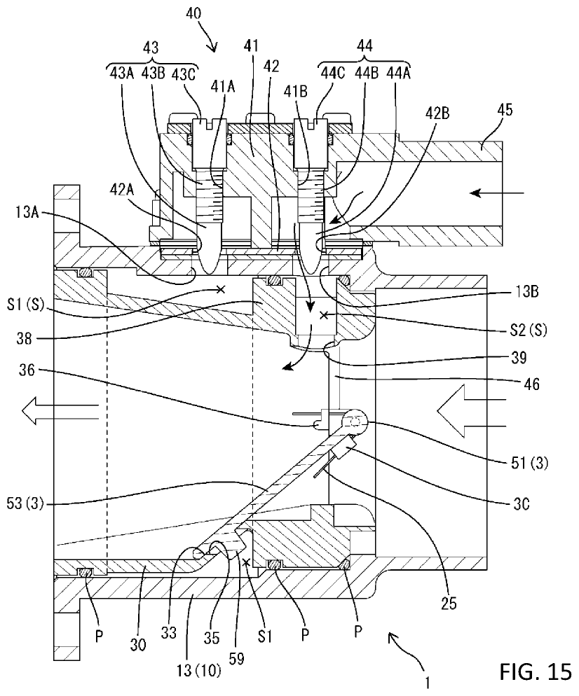

In the fluid mixer of the fourth embodiment having such a configuration, the elastic force of the elastic body 25 acts on the valve body 3. That is, the elastic body 25, which is a torsion spring, exerts an elastic force in the valve closing direction of the valve body 3. In the fluid mixer, as shown in FIG. 15, when the flow rate of the first fluid flowing in the inner cylinder 30 of the Venturi tube 1 is so small that it is not possible to overcome the elastic force of the elastic body 25 acting on the valve body 3, and the valve body 3 is not opened, only the second fluid flowing in from the second inflow opening 39 is mixed with the first fluid. At this time, the flow rate of the second fluid from the second inflow opening 39 can be adjusted by adjusting the adjustment screw 44 of the flow rate adjusting section 40. That is, the adjustment screw 44 can adjust only the flow rate of the second fluid flowing through the gap S2, and the second fluid flowing through the gap S2 communicates with the second inflow opening 39. Accordingly, it can be easily adjusted so as to cause the second fluid of the flow rate corresponding to the flow rate of the first fluid flowing through the constriction section at the time of closing the valve to flow in from the second inflow opening 39.

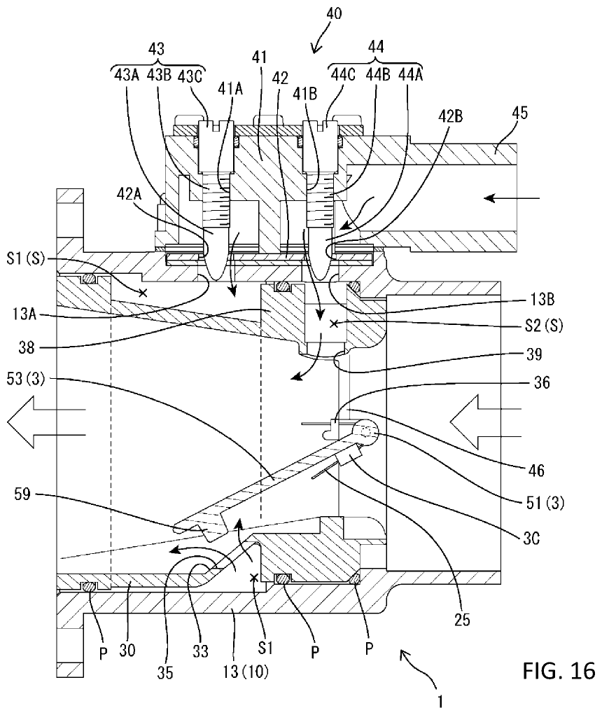

In addition, in the fluid mixer, when the valve body 3 is subjected to a dynamic pressure that slightly overcomes the elastic force of the elastic body 25 acting on the valve body 3, the valve body 3 is slightly opened as shown in FIG. 16. Due to this, in addition to the second fluid flowing in from the second inflow opening 39, the second fluid flowing in from the first inflow opening 35 is mixed with the first fluid. At this time, the flow rate of the first fluid flowing through the constriction section is larger than the flow rate when the valve body 3 is closed, but is smaller than the flow rate when the valve body 3 is fully opened. Then, at this time, since the protrusion portion 59 is inserted into the first inflow opening 35, the flow path area of the first inflow opening 35 is smaller than that in the case where the valve body 3 is fully opened. Accordingly, in the state where the valve body 3 is slightly opened, the second fluid having a flow rate corresponding to the opening degree of the valve body 3 flows in from the first inflow opening 35. Thus, in the case where the opening degree of the valve body 3 is small, such as when the valve body 3 is switched between being opened and closed, a rapid change in the flow rate of the second fluid flowing in from the first inflow opening 35 is suppressed.

At this time, the flow rate of the second fluid flowing in the constriction section from the first inflow opening 35 can be adjusted by adjusting the adjustment screw 43 of the flow rate adjusting section 40. The flow rate of the second fluid from the first inflow opening 35 can be adjusted without changing the flow rate of the second fluid flowing in from the second inflow opening 39. Accordingly, it is possible to adjust only the flow rate of the second fluid flowing in from the first inflow opening 35 so that the mixing ratio of the first fluid and the second fluid when the valve body 3 is opened becomes appropriate without affecting the mixing ratio of the first fluid and the second fluid when the valve body 3 is closed.

Next, a description will be given regarding a case where the fluid mixer of the fourth embodiment having such a configuration is incorporated into a combustion apparatus similar to the combustion apparatus 7 (see FIG. 4) of the first embodiment. In other words, a description will be given regarding a case where the fluid mixer of the fourth embodiment is used by being coupled to the upstream side of the blower that supplies combustion air to the burner of the combustion apparatus. In this case, as in the first embodiment, the first fluid is air and the second fluid is combustion gas. In the fluid mixer, the combustion gas is supplied from the supply tube portion 45, and the combustion gas of which the flow rate has been adjusted by the flow rate adjusting section 40 is supplied into the Venturi tube 1.

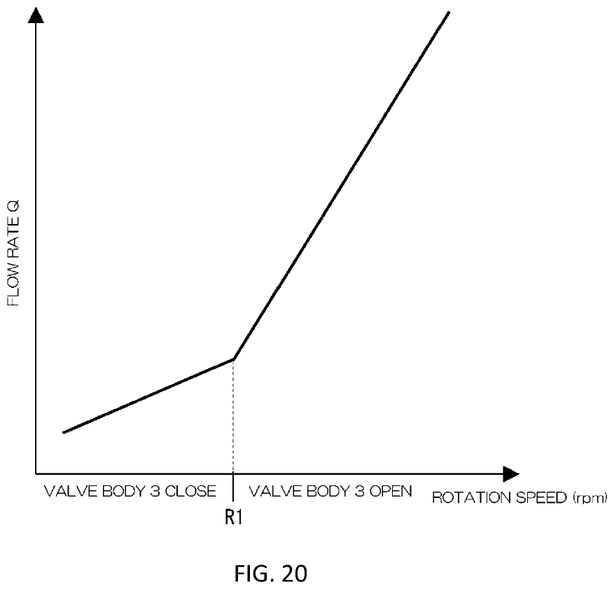

When the combustion apparatus is to be combusted at a low combustion amount, the blower is rotated at a low set rotation speed (rotation speed lower than the rotation speed R1 shown in FIG. 20). In this case, since the pressure of the air passing through the inside of the inner cylinder 30 of the Venturi tube 1 is low, this pressure cannot overcome the elastic force of the elastic body 25 as the biasing part that biases the valve body 3 in the valve closing direction, and the valve body 3 becomes in a valve closing state (see FIG. 15). For this reason, the air as the first fluid flows through the Venturi tube 1 having a flow path area that becomes about half in a state where the valve body 3 is not opened. Since the valve body 3 is closed, the combustion gas as the second fluid does not flow into the Venturi tube 1 from the first inflow opening 35, but flows in only from the second inflow opening 39. Accordingly, similar to the first embodiment, it is possible to supply the mixed gas with an air-fuel ratio appropriate for combustion in which the air of a small flow rate passing through the Venturi tube 1 having a flow path area of about half and the combustion gas of a small flow rate flowing in only from the second inflow opening 39 are mixed.

On the other hand, when the combustion apparatus is to be combusted at a high combustion amount, the blower is rotated at a high set rotation speed (rotation speed higher than the rotation speed R1 shown in FIG. 20). In this case, since the pressure of the air passing through the inner cylinder 30 of the Venturi tube 1 is high, this pressure overcomes the elastic force of the elastic body 25 and the valve body 3 is opened (see FIG. 16). For this reason, the air as the first fluid flows through the Venturi tube 1 having a flow path area corresponding to the opening degree of the valve body 3. The first inflow opening 35 is opened by the valve body 3 being opened, and the combustion gas as the second fluid flows in from both the first inflow opening 35 and the second inflow opening 39. Accordingly, it is possible to supply the mixed gas with an air-fuel ratio appropriate for combustion in which the air passing through the Venturi tube 1 having a large flow path area due to the opening of the valve body 3 and more combustion gas obtained by combining the combustion gas from the second inflow opening 39 and the combustion gas flowing in from the opened first inflow opening 35 are mixed.

In the case where the blower is rotated at a rotation speed slightly higher than the rotation speed when the valve body 3 is closed (rotation speed slightly higher than the rotation speed R1 shown in FIG. 20), the valve body 3 is opened in a state where the opening degree is small, and the protrusion portion 59 is inserted into the first inflow opening 35 (see FIG. 19). At this time, air having a flow rate slightly higher than that at the time of valve closing in a state where the opening degree of the valve body 3 is small flows through the Venturi tube 1. Then, at this time, since the protrusion portion 59 is inserted into the first inflow opening 35, the combustion gas flowing in from the first inflow opening 35 flows in at a flow rate corresponding to a small flow path area. Accordingly, even when the opening degree of the valve body 3 is small, it is possible to supply the mixed gas with an air-fuel ratio appropriate for combustion in which the air passing through the Venturi tube 1 having a flow path area corresponding to the opening degree of the valve body 3 and the combustion gas obtained by combining the combustion gas from the second inflow opening 39 and the combustion gas flowing in from the slightly opened first inflow opening 35 are mixed.

As described above, the fluid mixer of the fourth embodiment has one valve body 3 that changes the flow path area of the Venturi tube 1, and the elastic force of the elastic body 25 acts on the valve body 3 in the valve closing direction. For this reason, in the fluid mixer, the pressure of the first fluid passing through the Venturi tube 1 overcomes the elastic force of the elastic body 25, whereby the valve body 3 is opened. Therefore, by including the elastic body 25 that generates an appropriate elastic force, the fluid mixer can stably open the valve body 3 at an opening degree corresponding to the pressure of the first fluid passing through the Venturi tube 1, and can cause the second fluid having a flow rate corresponding to the flow rate of the first fluid to flow in. Accordingly, the fluid mixer of the fourth embodiment can stably supply a mixed fluid having a desired mixing ratio. In addition, since the fluid mixer of the fourth embodiment has one valve body 3, the length in the flow path direction can be shortened.

Furthermore, in the fluid mixer of the fourth embodiment, the valve body 3 has the protrusion portion 59 inserted into the first inflow opening 35. For this reason, it is possible to suppress a rapid change in the flow rate of the second fluid flowing in from the inflow opening at the time of switching the valve body 3 between being opened and closed.

In the fluid mixer of the fourth embodiment, the Venturi tube 1 communicates with the inflow openings (the first inflow opening 35 and the second inflow opening 39), and the gaps S (S1 and S2) as flow passages through which the second fluid flows is formed. The fluid mixer includes the flow rate adjusting section 40 provided in the Venturi tube 1 to adjust the flow rate of the second fluid flowing through the gaps S (S1 and S2) as the flow passage. The flow rate adjusting section 40 has the operating section 43C (adjustment screw 43) that adjusts the flow rate of the second fluid from the outside of the Venturi tube 1. For this reason, the flow rate of the second fluid can be easily adjusted.

Furthermore, in the fluid mixer of the fourth embodiment, the Venturi tube 1 has the inner cylinder 30 forming the constriction section and the outer cylinder 10 into which the inner cylinder 30 is inserted. By inserting the inner cylinder 30 into the outer cylinder 10, the gaps S (S1 and S2) as the flow passage is formed between the outer peripheral surface of the inner cylinder 30 and the inner peripheral surface of the outer cylinder 10. For this reason, the flow passage can be easily formed in the Venturi tube 1.

In the fluid mixer of the fourth embodiment, the plurality of inflow openings are the first inflow opening 35 opened and closed by the valve body 3 and the second inflow opening 39, which is the inflow opening other than the first inflow opening 35. The gaps S as the flow passage has the gap S1 as the first flow passage communicating with the first inflow opening 35 and the gap S2 as the second flow passage communicating with the second inflow opening 39. The flow rate adjusting section 40 has the orifice plate 42 in which the hole 42A is formed and the adjustment screw 43 that serve as the first flow rate adjusting section that adjusts the flow rate of the second fluid flowing through the gap S1 serving as the first flow passage, and has the orifice plate 42 in which the hole 42B is formed and the adjustment screw 44 that serve as the second flow rate adjusting section that adjusts the flow rate of the second fluid flowing through the gap S2 serving as the second flow passage. For this reason, it is possible to individually adjust the flow rate of the second fluid flowing in from each of the first inflow opening 35 opened and closed by the valve body 3 and the second inflow opening 39, which is the inflow opening other than the first inflow opening 35. It is also possible to obtain a mixed fluid having a desired mixing ratio regardless of whether the valve is opened or closed.

### Fifth Embodiment

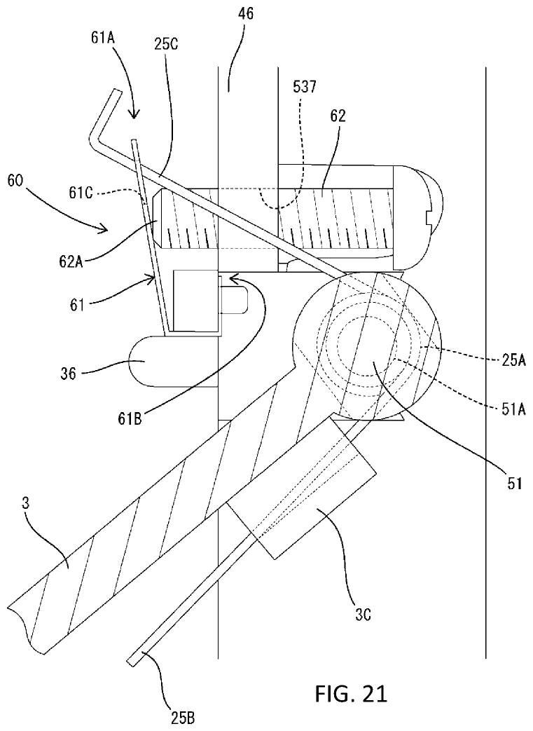

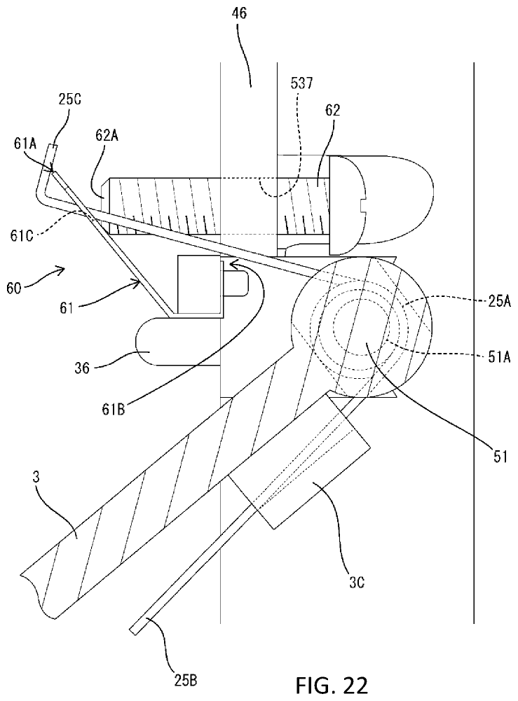

As shown in FIGS. 21 and 22, the fluid mixer of the fifth embodiment includes, in addition to the configuration of the fluid mixer of the fourth embodiment, an elastic force adjusting section as an adjusting section that adjusts the pressure of the first fluid passing through the Venturi tube 1 when the valve body is opened so as to be different. In addition, the same configurations as those of the embodiments described above are given the identical reference numerals, and detailed description thereof will be omitted.

As shown in FIGS. 21 and 22, the fluid mixer of the fifth embodiment includes an elastic force adjusting section 60. The elastic force adjusting section 60 adjusts the magnitude of the elastic force that the elastic body 25, which is a torsion spring, acts on the valve body 3 in the valve closing direction. The elastic force adjusting section 60 has a leaf spring 61 and a machine bolt 62.

The leaf spring 61 has a free end on one end and a fixed end on the other end. More specifically, as shown in FIGS. 21 and 22, the leaf spring 61 is formed in a substantially J-shape in cross section, in which an end portion 61A serving as a free end is long and an end portion 61B serving as a fixed end is short. The leaf spring 61 is fixed by being locked with the contact stopping portion 36 on the end portion 61B side. This causes the end portion 61A of the leaf spring 61 to be elastically deformable about the end portion 61B side. The end portion 61A is formed with a long hole 61C. The end portion 25C of the elastic body 25 is inserted into the long hole 61C.

The machine bolt 62 is screwed into a screw hole 537 formed by penetrating in the front-rear direction in the vicinity of the contact stopping portion 36 of the rib 46. The machine bolt 62 is inserted into the screw hole 537 with its tip end 62A facing downstream side. The tip end 62A of the machine bolt 62 is in contact with the end portion 61A side of the leaf spring 61.

When the elastic force of the elastic body 25 is adjusted by the elastic force adjusting section 60, the screw amount into the screw hole 537 is changed by rotating the machine bolt 62. For example, when the machine bolt 62 in the state shown in FIG. 21 is further rotated in the screwing direction, the tip end 62A of the machine bolt 62 moves in the downstream direction. Then, the end portion 61A of the leaf spring 61 coming into contact with the tip end 62A of the machine bolt 62 is pressed in the downstream direction. At this time, since the leaf spring 61 is fixed on the end portion 61B side, it rotates about the end portion 61B side and falls over to the downstream side. Then, since the end portion 25C of the elastic body 25 is inserted into the long hole 61C, it falls over to the downstream side together with the leaf spring 61, and is closer to the end portion 25B of the elastic body 25 than that in the original state. Due to this, the preload of the torsion spring as the elastic body 25 is further increased, and is adjusted so that the elastic force in the valve closing direction is more strongly applied to the valve body 3. Due to this, the pressure of the first fluid when the valve body 3 is opened is further increased.

On the other hand, in order to further reduce the pressure of the first fluid when the valve body 3 is opened, the machine bolt 62 is rotated in the loosening direction, and the tip end 62A is moved to the upstream side. Then, the end portion 61A of the leaf spring 61 rises. Along with this, the end portion 25C of the elastic body 25 moves in a direction away from the end portion 25B. For this reason, the preload of the torsion spring as the elastic body 25 is weakened, and the valve body 3 is opened at a lower pressure.

It is to be noted that the elastic force adjusting section is not limited to the above configuration. When the fluid mixer includes an elastic force adjusting section as an adjusting section according to the present invention, the elastic force adjusting section is not particularly limited in terms of its configuration so long as the pressure of the first fluid passing through the Venturi tube when the valve body is opened is different.

As described above, the fluid mixer of the fifth embodiment has the same effect as that of the fourth embodiment.

The fluid mixer of the fifth embodiment includes the elastic force adjusting section 60 as an adjusting section. For this reason, it is possible to easily change the flow rate of the mixed fluid by adjusting the pressure of the air passing through the Venturi tube 1 when the valve body 3 is opened so as to be different, depending on the screwing condition of the machine bolt 62.

### OTHER EMBODIMENTS

The present invention is not limited to the first to fifth embodiments described above and illustrated in the drawings, and, for instance, the following embodiments are also included in the technical scope of the present invention.

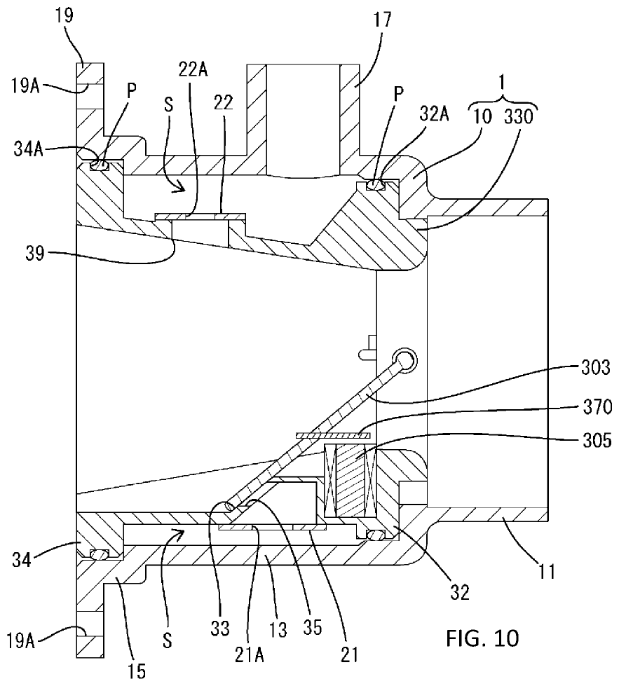

(1) In the first to third embodiments, the magnetic force of the permanent magnet provided in the valve body is applied in the valve closing direction of the valve body. However, the magnetic force of an electromagnet 305 may be applied in the valve closing direction of a valve body 303 by attaching a flat plate-shaped iron piece 370 so as to extend to the upstream side from the valve body 303 in the valve closing state, and by attaching the electromagnet 305 to an inner cylinder 330 so that the end face of the electromagnet 305 is disposed at a position facing the iron piece 370, as shown in FIG. 10. In this case, if the magnitude of the electric power supplied to the electromagnet 305 is changed, the flow rate of the mixed fluid can be finely controlled or easily changed.

In addition, the power supply to the electromagnet 305 may be cut off by detecting that the rotation speed of the blower 7A has reached a predetermined rotation speed. Also in this case, the valve body 303 can stably maintain the valve opening state, thereby allowing the mixed fluid of a desired mixing ratio to be stably supplied.

In FIG. 10, the same configurations as those of the first embodiment are given the identical reference numerals.

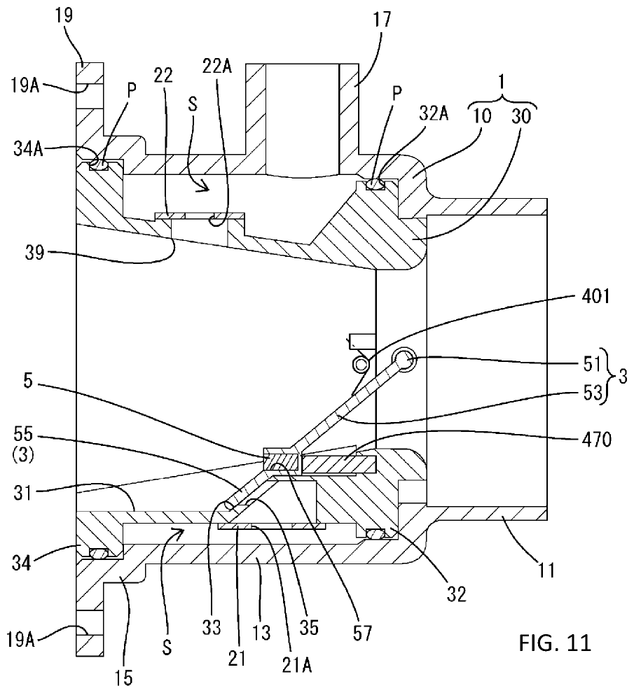

(2) In the first and third embodiments, the magnetic force causing the valve body to act in the valve closing direction is adjusted by bringing the magnet and the tip end surface of the bolt close to or away from each other, depending on the screwing condition of the bolt. However, as shown in FIG. 11, instead of the bolt, an iron rod member 470 on which the magnetic force of the magnet 5 acts may be fixed to the inner cylinder 30 so as not to move, and a torsion spring 401 may be attached so that the elastic force of the torsion spring 401 acts on the valve body 3 in the valve closing direction. In this case, a plurality of torsion springs 401 having different elastic forces may be prepared, and the pressure of the air passing through the Venturi tube 1 when the valve body 3 is opened may be adjusted so as to be different.

In FIG. 11, the same configurations as those of the first embodiment are given the identical reference numerals.

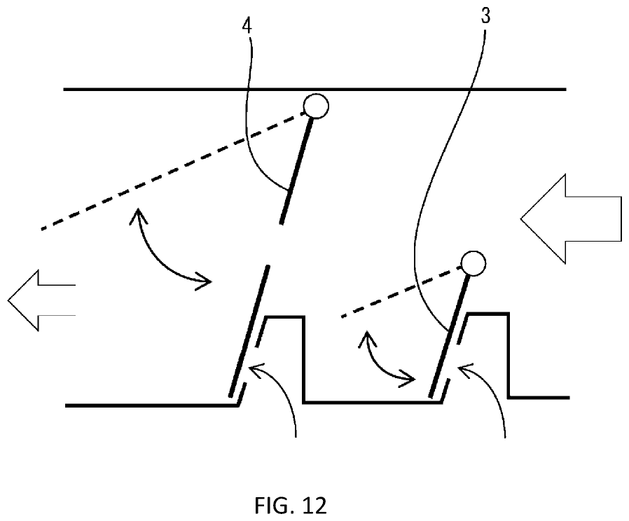

(3) As shown in FIG. 12, the valve body 3 capable of blocking substantially half of the flow path similar to the valve body of the first embodiment, and, on downstream side relative to the valve body 3, the valve body 4 capable of blocking substantially the entire flow path similar to the valve body of the third embodiment may be included.

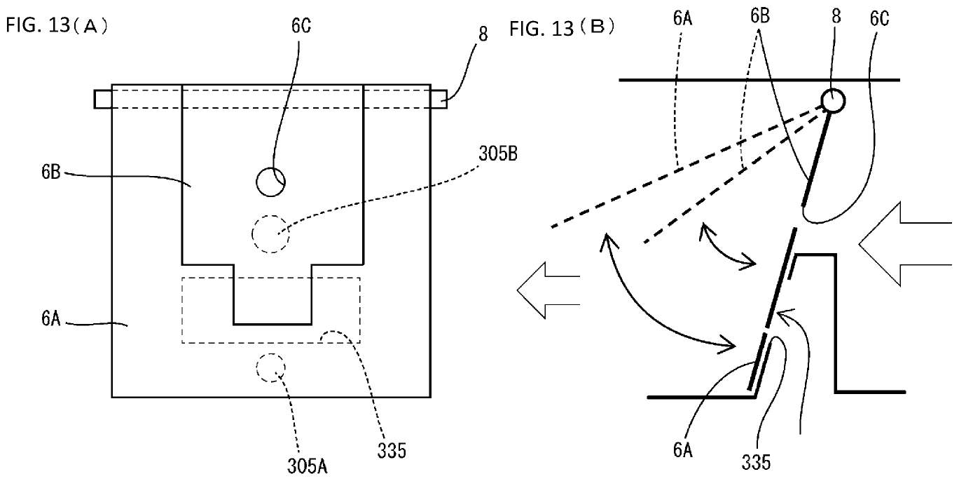

(4) In the second embodiment, the valve body is divided into two symmetrical shapes. However, as shown in FIG. 13, the valve body may be divided into a first valve body 6A formed to a size in which substantially the entire flow path is blocked, and a second valve body 6B in that opens and closes the center part of the first valve body 6A. The first valve body 6A and the second valve body 6B rotate about an identical rotating shaft 8 continuous to the upper end edge. The first valve body 6A is attached with a magnet 305A applying a magnetic force in the valve closing direction. The second valve body 6B is attached with a magnet 305B applying a magnetic force in the valve closing direction. The second valve body 6B has a through hole 6C formed in the center. The tip end portion of the second valve body 6B opens and closes the center part of an inflow opening 335, and the first valve body 6A opens and closes the region of the inflow opening 335 other than the region where the second valve body 6B opens and closes.

(5) In the first to fifth embodiments, the fluid mixer is assembled to the combustion apparatus, and it is assumed that the first fluid and the second fluid are gases, such as that the first fluid is air and the second fluid is combustion gas. However, at least one of the first fluid and the second fluid may be a liquid.

(6) In the first to fifth embodiments, the fluid mixer is assembled to the combustion apparatus. However, it may be assembled to another apparatus.

(7) In the first to fifth embodiments, the Venturi tube is constituted by an outer cylinder and an inner cylinder. However, the Venturi tube may be formed by a single tube member.

(8) In the second embodiment, the valve body is divided into two. However, the valve body may be divided into three or more.

(9) In the first and third embodiments, the distance to the magnet is brought close or away, depending on the screwing condition of the bolt. However, a member made of iron or the like on which the magnetic force of the magnet acts may be fixed to the inner cylinder so that the distance to the magnet does not change.

(10) In the first to fifth embodiments, the fluid mixer is coupled to the upstream side of the blower. However, the fluid mixer may be coupled to the downstream side of the blower.

(11) In the fourth and fifth embodiments, a torsion spring is exemplified as an elastic body as a biasing part. However, the elastic body is not limited to a torsion spring, and various forms such as a compression coil spring, a tension coil spring, and a leaf spring may be employed. The material of the elastic body can be metal, resin, elastomer such as rubber, or the like. Furthermore, the biasing part according to the present invention may be constituted of a combination of biasing parts of a plurality of different forms such as a combination of a magnet and an elastic body, in addition to the constitution of only an elastic body as in the present embodiments and the constitution of only a magnet as in the first to third embodiments.

(12) While the fourth and fifth embodiments exemplify a form in which the valve body has a protrusion portion, this is not essential. In the case where the valve body has a protrusion portion, its shape, size, and the like are not particularly limited as long as it can be inserted into the first inflow opening.

(13) The fourth and fifth embodiments exemplify one orifice plate having been formed with two holes for adjusting the flow rate corresponding to the first flow passage and the second flow passage, respectively. However, alternatively, a form in which two orifice plates having been formed with one hole may be employed.

(14) While the fifth embodiment exemplifies a form in which the elastic force adjusting section is included as an adjusting section, this is not an essential configuration.

### REFERENCE SIGNS LIST

1 Venturi tube
3, 3A, 3B, 4, 6A, 6B valve body
(3A, 6A first valve body 3B, 6B second valve body)
5, 305A, 305B magnet (biasing part)
25 elastic body (biasing part)
35, 39, 135, 235, 239, 335 inflow opening (35, 135, 235, 335 first inflow opening 39, 239 second inflow opening)
60 elastic force adjusting section (adjusting section)
70 bolt (adjusting section)

1. A fluid mixer, comprising:
a Venturi tube having a constriction section at which the flow path area is reduced, the Venturi tube having a plurality of inflow openings formed therein, through which a second fluid flows into a low-pressure region generated due to an increase in fluid velocity when a first fluid passes through the constriction section;
a valve body disposed in the Venturi tube, the valve body opened due to a pressure of the first fluid passing through the Venturi tube and changing the flow path area of the Venturi tube, as well as blocking some of the plurality of inflow openings when the valve body is closed and opening the same when the valve body is opened; and
a biasing part applying a biasing force in a valve closing direction of the valve body,
wherein the valve body has a protrusion portion inserted into the inflow opening, and
the cross-sectional area of the protrusion portion is configured to be smaller than the opening area of the inflow opening.

2. The fluid mixer according to claim 1, wherein the biasing part has an elastic body applying an elastic force in the valve closing direction.

3. A fluid mixer, comprising:
a Venturi tube having a constriction section at which the flow path area is reduced, the Venturi tube having a plurality of inflow openings formed therein, through which a second fluid flows into a low-pressure region generated due to an increase in fluid velocity when a first fluid passes through the constriction section;
a valve body disposed in the Venturi tube, the valve body opened due to a pressure of the first fluid passing through the Venturi tube and changing the flow path area of the Venturi tube, as well as blocking some of the plurality of inflow openings when the valve body is closed and opening the same when the valve body is opened; and
a biasing part applying a biasing force in a valve closing direction of the valve body, wherein the biasing part has a magnet applying a magnetic force in the valve closing direction.

4. (canceled)

5. The fluid mixer according to claim 1, wherein
the Venturi tube is formed with a flow passage communicating with the inflow opening, the flow passage through which the second fluid flows,
the fluid mixer includes a flow rate adjusting section provided in the Venturi tube, the flow rate adjusting section adjusting a flow rate of the second fluid flowing through the flow passage, and
the flow rate adjusting section has an operating section adjusting the flow rate of the second fluid from an outside of the Venturi tube.

6. The fluid mixer according to claim 5, wherein
the Venturi tube has an inner cylinder forming the constriction section and an outer cylinder into which the inner cylinder is inserted, and
by inserting the inner cylinder into the outer cylinder, the flow passage is formed between an outer peripheral surface of the inner cylinder and an inner peripheral surface of the outer cylinder.

7. The fluid mixer according to claim 5, wherein
the plurality of inflow openings are a first inflow opening opened and closed by the valve body and a second inflow opening other than the first inflow opening,
the flow passage has a first flow passage communicating with the first inflow opening and a second flow passage communicating with the second inflow opening, and
the flow rate adjusting section has a first flow rate adjusting section adjusting a flow rate of a second fluid flowing through the first flow passage, and a second flow rate adjusting section adjusting a flow rate of a second fluid flowing through the second flow passage.

8. The fluid mixer according to any one of claim 1, wherein the inflow opening opened and closed by the valve body is formed downstream relative to a part of the constriction section having a smallest flow path area and upstream relative to a tip end position of the valve body when the valve is closed.

9. A fluid mixer, comprising:
a Venturi tube having a constriction section at which the flow path area is reduced, the Venturi tube having a plurality of inflow openings formed therein, through which a second fluid flows into a low-pressure region generated due to an increase in fluid velocity when a first fluid passes through the constriction section;
a valve body disposed in the Venturi tube, the valve body opened due to a pressure of the first fluid passing through the Venturi tube and changing the flow path area of the Venturi tube, as well as blocking some of the plurality of inflow openings when the valve body is closed and opening the same when the valve body is opened; and
a biasing part applying a biasing force in a valve closing direction of the valve body,
wherein the valve body is formed divided, where a pressure of the first fluid passing through the Venturi tube when each divided valve body is opened is different, and the inflow opening is blocked for each divided valve body when the valve is closed, and the inflow opening is opened for each divided valve body when the valve is opened.

10. A fluid mixer, comprising:
a Venturi tube having a constriction section at which the flow path area is reduced, the Venturi tube having a plurality of inflow openings formed therein, through which a second fluid flows into a low-pressure region generated due to an increase in fluid velocity when a first fluid passes through the constriction section;
a valve body disposed in the Venturi tube, the valve body opened due to a pressure of the first fluid passing through the Venturi tube and changing the flow path area of the Venturi tube, as well as blocking some of the plurality of inflow openings when the valve body is closed and opening the same when the valve body is opened;
a biasing part applying a biasing force in a valve closing direction of the valve body; and
an adjusting section adjusting a pressure of the first fluid passing through the Venturi tube when the valve body is opened so as to be different.

11. The fluid mixer according to claim 6, wherein
the plurality of inflow openings are a first inflow opening opened and closed by the valve body and a second inflow opening other than the first inflow opening,
the flow passage has a first flow passage communicating with the first inflow opening and a second flow passage communicating with the second inflow opening, and
the flow rate adjusting section has a first flow rate adjusting section adjusting a flow rate of a second fluid flowing through the first flow passage, and a second flow rate adjusting section adjusting a flow rate of a second fluid flowing through the second flow passage.

12. The fluid mixer according to any one of claim 11, wherein the inflow opening opened and closed by the valve body is formed downstream relative to a part of the constriction section having a smallest flow path area and upstream relative to a tip end position of the valve body when the valve is closed.
